(19) United States
(12) Patent Application Publication
(10) Pub. No.: US 2020/0274726 A1
(43) Pub. Date: Aug. 27, 2020

(54) GRAPHICAL INTERFACE DESIGNED FOR SCHEDULING A MEETING

(71) Applicant: TeaMeet Technologies Ltd., Petach-Tikva (IL)

(72) Inventors: Hana-Muriel SETTEBOUN, Tel-Aviv (IL); Netanel Robin, Tel-Aviv (IL)

(73) Assignee: TeaMeet Technologies Ltd., Petach-Tikva (IL)

(21) Appl. No.: 16/798,537

(22) Filed: Feb. 24, 2020

Related U.S. Application Data
(60) Provisional application No. 62/809,652, filed on Feb. 24, 2019.

(51) Int. Cl. H04L 12/18; G06F 3/01; G06F 3/0482

(52) U.S. Cl. CPC H04L 12/1818; G06F 3/0482; G06F 3/017; H04L 12/1822

(57) ABSTRACT

A method comprising: identifying a gesture performed via a GUI, for navigating a set of user credentials from a list into respective regions within a priority scale having regions indicative of relative priority for attendance, sending to the user credentials, invitations including time slots and locations each associated with a relative ranking score, receiving responses, each associated with relative response ranking score and a participation score, and computing a single time slot and a single location by weighting the relative response ranking scores and participation scores for the time slots and locations, according to the region of the respective user credentials within the priority scale and according to the relative ranking score assigned to each time slot and each location, and presenting, within the priority scale of the GUI, color coding indicative of likelihood of attendance at the single time slot and the single location by each user credential.

### RELATED APPLICATIONS

This application claims the benefit of priority under 35 USC § 119(e) of U.S. Provisional Patent Application No. 62/809,652 filed on Feb. 24, 2019, the contents of which are incorporated by reference as if fully set forth herein in their entirety.

### FIELD AND BACKGROUND OF THE INVENTION

The present invention, in some embodiments thereof, relates to graphical user interfaces and, more specifically, but not exclusively, to graphical user interfaces designed to schedule meetings.

Scheduling a meeting is usually performed by a coordinator that manually select some options based on availability of a meeting organizer and tries to manually fit the options to the invited participants.

### SUMMARY OF THE INVENTION

According to a first aspect, a method of scheduling a meeting with a graphical user interface (GUI), comprises: presenting within the GUI, a list of user credentials for attending the meeting, and a priority scale having regions indicative of relative priority for attendance, identifying a gesture performed via the GUI, for navigating a set of the user credentials from the list into respective regions within the priority scale, sending to each one of the set of user credentials, an invitation including a plurality of time slots and a plurality of locations each associated with a relative ranking score, receiving a plurality of responses, each associated with relative response ranking score and a participation score indicative of likelihood of participation by the respective user credentials in attending each respective time slot, and each respective location, and computing optimal time slots and optimal locations by weighting the relative response ranking scores and participation scores for the plurality of time slots and plurality of locations from the plurality of responses, according to the region of the respective user credentials within the priority scale and according to the relative ranking score assigned to each time slot and each location, and presenting, within the priority scale of the GUI, color coding indicative of likelihood of attendance of the meeting scheduled at the single time slot and the single location by each of the plurality of user credentials.

In a further implementation of the first aspect, the plurality of time slots, the plurality of locations, and associated relative ranking scores are automatically computed by a classifier based on an analysis of a future meeting dataset of a current user organizing the meeting, and based on an analysis of a historical meeting dataset of the current user storing historical scheduled time slots, historical locations, and historical associated relative ranking scores, and wherein the responses are computed by the classifier based on an analysis of a future meeting dataset of each respective user credentials invited to meeting, and based on an analysis of a historical meeting dataset of the respective user credentials storing historical scheduled time slots, historical locations, and historical associated relative ranking scores.

In a further implementation of the first aspect, the plurality of locations, and associated relative ranking scores are automatically predicted and/or recommended by a machine learning model that is dynamically updated and trained by being fed actual real data entered by the users organizing meetings and/or events via the GUI, the received responses, and ground truth of the actual set meeting time slots and/or locations, and actual attendance at the meeting set according to corresponding time slots and locations.

In a further implementation of the first aspect, the machine learning model is trained on and is fed an indication of gestures performed by the user setting up the meeting, and/or by the responding users.

In a further implementation of the first aspect, the machine learning model is trained on and is fed current and/or future geographical locations of the user setting up the meeting and/or of the responding users.

In a further implementation of the first aspect, user credentials of the list are each associated with a presented meeting rating score which is performed by the user setting up the meeting, for the meeting itself, and/or on a computed ‘meeting rating score’ which is based on previous attendance to invited meetings and/or events, wherein user credentials that have a higher rate of attendance to invited meetings and/or events, and/or received high rating for previous meetings, are assigned a higher score relative to other user credentials that have a lower rate of attendance to invited meetings and/or events.

In a further implementation of the first aspect, the list set of user credentials for attending the meeting and/or event includes a plurality of predefined groups of user credentials, wherein the optimal time slots and optimal locations are presented within a calendar in the GUI presenting a summary of scheduled meetings and/or events for the plurality of predefined groups.

In a further implementation of the first aspect, wherein one certain user credential is a member of at least two predefined groups, and wherein the GUI automatically determines a conflict when the at least two predefined groups are set to occur during a common time optimal slot at different respective locations.

In a further implementation of the first aspect, the GUI automatically analyzes the conflict and presents at least one recommended solution to maintain the at least one certain user in one meeting and remove the at least one certain user from other meeting of the conflict.

In a further implementation of the first aspect, the list set of user credentials for attending the meeting and/or event includes a plurality of predefined groups of user credentials, and further comprising: presenting a group hub within the GUI in response to selection of one group of the plurality of groups, the group hub including at least one feature selected from the group consisting of: a group chat GUI for interactive communication between a plurality of user credentials of the one group, a group content feature for posting content and viewing the posted content within the GUI between the plurality of user credentials of the one group, an upcoming meeting and/or event feature for viewing within the GUI upcoming scheduled meetings and/or events including the one group, a create meeting and/or event feature for creating new meetings and/or events for the one group via the GUI, a reminder of meeting and/or event feature for creating custom reminders for upcoming scheduled meetings and/or events for transmission to client terminals of the plurality of user credentials of the one group, a view group calendar feature for presenting within the GUI a calendar including upcoming scheduled meetings and/or events, a plurality of folders each storing previously posted content and/or chats and/or content for viewing within the GUI, a group log storing a list of activities of the one group for viewing the GUI, and a group report GUI for creating reports from the group data and printing it and/or sharing it between a plurality of user credentials of the one group.

In a further implementation of the first aspect, the meeting comprises a current occurrence of a recurring meeting associated with at least one previous occurrence, wherein the list of user credentials for attending the meeting include user credentials that attended the at least one previous occurrence, and further comprising: presenting within the GUI, a summary for each at least one previous occurrence of the recurring meeting, the meeting summary including a plurality of fields selected from the group consisting of: invited user credentials, participating user credentials, key meeting details, meeting conclusion, and recommendations for following meetings, in response to an indication of termination of the current occurrence, generating an meeting feedback form including the plurality of fields, transmitting the meeting feedback form to the plurality of user credentials, receiving a plurality of replies, and aggregating the plurality of fields from the plurality of replies to generate a summary for the current occurrence.

In a further implementation of the first aspect, each invitation sent to each respective user credentials includes a link to access a GUI designed for setting a prioritization of the plurality of time slots and the plurality of locations by identifying a gesture of a respective user arranging the plurality of time slots and the plurality of locations in a list, wherein the relative ranking score is computed according to the relative location of the arranged plurality of time slots and the plurality of locations.

According to a second aspect, a method of scheduling an event with a GUI, comprises: presenting within the GUI, a list of user credentials for attending the event, and a priority scale having regions indicative of relative priority for attendance, identifying a gesture performed via the GUI, for navigating a set of the user credentials from the list into respective regions within the priority scale, sending to each one of the set of user credentials, an invitation including a single selected time slot and a single selected location, receiving a plurality of responses, each indicative of acceptance or decline of the invitation by the respective user credentials, and presenting, within the priority scale of the GUI, color coding indicative of attendance or no-attendance of the event by each of the plurality of user credentials.

In a further implementation of the second aspect, the event comprises a current occurrence of a recurring event associated with at least one previous occurrence, wherein the list of user credentials for attending the event include user credentials that attended the at least one previous occurrence, and further comprising: presenting within the GUI, a summary for each at least one previous occurrence of the recurring event, the event summary including a plurality of fields selected from the group consisting of: invited user credentials, participating user credentials, key event details, event conclusion, and recommendations for following events, in response to an indication of termination of the current occurrence, generating an event feedback form including the plurality of fields, transmitting the event feedback form to the plurality of user credentials, receiving a plurality of replies, and aggregating the plurality of fields from the plurality of replies to generate a summary for the current occurrence.

In a further implementation of the second aspect, the GUI includes a selection option that when selected presents a set of user credentials that attended another event, wherein the set of user credentials that attended another event have a meeting rating score computed based on previous attendance to invited meetings and/or events, wherein at least one of the set of user credentials that attended another event is navigate into respective regions within the priority scale.

According to a third aspect, a method of managing groups with a GUI comprises: in response to a first selection, presenting within the GUI, a plurality of predefined groups of user credentials, wherein the plurality of predefined groups are for selection for participation in a scheduled meeting and/or event, in response to a second selection, presenting within an interactive calendar in the GUI, a summary of scheduled meetings and/or events for the plurality of predefined groups, wherein the interactive calendar is responsive to selection of a certain predefined group and/or certain scheduled meeting and/or certain scheduled event for editing thereof by a user, and in response to a third selection of one group of the plurality of predefined groups, presenting a group hub within the GUI, the group hub including at least one feature selected from the group consisting of: a group chat GUI for interactive communication between a plurality of user credentials of the one group, a group content feature for posting content and viewing the posted content within the GUI between the plurality of user credentials of the one group, an upcoming meeting and/or event feature for viewing within the GUI upcoming scheduled meetings and/or events including the one group, a create meeting and/or event feature for creating new meetings and/or event for the one group via the GUI, a reminder of meeting and/or event feature for creating custom reminders for upcoming scheduled meetings and/or event for transmission to client terminals of the plurality of user credentials of the one group, a view group calendar feature for presenting within the GUI a calendar including upcoming scheduled meetings and/or events, a plurality of folders each storing previously posted content and/or chats and/or content for viewing within the GUI, a group log storing a list of activities of the one group for viewing the GUI, and a group report GUI for creating reports from the group data and printing it and/or sharing it between a plurality of user credentials of the one group.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

FIG. 1 is a block diagram of components of a system for creating a meeting and/or creating an event and/or managing groups attending events and/or meetings, by a GUI, in accordance with some embodiments of the present invention;

FIG. 2A is a flowchart of a process for creating a meeting by a GUI, in accordance with some embodiments of the present invention;

FIG. 2B is a flowchart of a process for creating an event by a GUI, in accordance with some embodiments of the present invention;

FIG. 2C is a flowchart of a process for managing groups attending events and/or meetings, by a GUI, in accordance with some embodiments of the present invention;

FIG. 3 is a flowchart of an exemplary process for using a GUI for selecting a time slot and location based on priority scale locations assigned to user credentials, ranking scores of time slots and locations or for selecting the time slot based on the auto-picker option, and participation scores provided by user credentials responding to invitations to attend the meeting at the time slots and/or locations, in accordance with some embodiments of the present invention;

FIG. 4 is a flowchart of exemplary user experiences and actions provided by the GUI described herein, in accordance with some embodiments of the present invention;

FIG. 5 is a flowchart of exemplary screen flows provided by the GUI described herein, in accordance with some embodiments of the present invention;

FIG. 6 is an exemplary screen of the GUI for registration, in accordance with some embodiments of the present invention;

FIG. 7 is an exemplary screen shot of the GUI when the user clicks the create account button and a message indicating the near completion of the registration process pops up, in accordance with some embodiments of the present invention;

FIG. 8 is an exemplary screen of the GUI at log-in, when users of the GUI are required to provide their user credentials (e.g., Email) and password that they filled during registration, in accordance with some embodiments of the present invention;

FIG. 9 is a screen shot of the GUI for password recovery where the user is required to provide the email used in registration, in accordance with some embodiments of the present invention;

FIG. 10 is an exemplary GUI screen presenting a New Meeting Page, in accordance with some embodiments of the present invention;

FIG. 11 includes an exemplary GUI screen for defining candidate time slots for the meeting manually, in accordance with some embodiments of the present invention;

FIG. 12 is an exemplary GUI screen for selecting an auto picker option that calculate automatically a single time slot (representing the most optimal selection) for a meeting between all the invited users, in accordance with some embodiments of the present invention;

FIG. 13 is an exemplary GUI screen depicting an Invitation Page, in accordance with some embodiments of the present invention;

FIG. 14 is an exemplary GUI screen depicting a second configuration of an Invitation Page when the current user enabled the auto picker option, in accordance with some embodiments of the present invention;

FIG. 15 is an exemplary GUI screen for a Ready Meeting Page, representing a concluded meeting in accordance with some embodiments of the present invention;

FIG. 16 is an exemplary GUI screen depicting a link to a Final Invitation Page, in accordance with some embodiments of the present invention;

FIG. 17 is an exemplary GUI screen depicting a complete page view as seen by a user upon scheduling a new event, in accordance with some embodiments of the present invention;

FIG. 18 is an exemplary GUI screen depicting a selection of user credentials for attending a new event, in accordance with some embodiments of the present invention;

FIG. 19 is an exemplary GUI screen depicting an invitation to an event, in accordance with some embodiments of the present invention;

FIG. 20 is an exemplary GUI screen depicting a “Meeting Sent Page”, in accordance with some embodiments of the present invention;

FIG. 21 is an exemplary GUI screen depicting an “Edit Meeting Page” of the GUI, in accordance with some embodiments of the present invention;

FIG. 22 is an exemplary GUI screen presenting a listed view of all the user meetings that occurred in the past, in accordance with some embodiments of the present invention;

FIG. 23 is an exemplary GUI screen depicting a GUI of Meeting Report Page for filling out a post-meeting report, in accordance with some embodiments of the present invention;

FIG. 24 is an exemplary GUI screen depicting the listed view, which allows sorting the events by the parameters mentioned above and provide a search option for a more specific search, in accordance with some embodiments of the present invention;

FIG. 25 is an exemplary GUI screen that presents detailed information about the event, in accordance with some embodiments of the present invention;

FIG. 26 is an exemplary GUI screen presenting a specific selected meeting that the user credentials is invited to, in accordance with some embodiments of the present invention;

FIG. 27 is an exemplary GUI screen presenting an “Events History Page”, in accordance with some embodiments of the present invention;

FIG. 28 is an exemplary GUI screen presenting an event report, in accordance with some embodiments of the present invention;

FIG. 29 is an exemplary GUI screen presenting User Contacts List, in accordance with some embodiments of the present invention;

FIG. 30 is an exemplary GUI screen presenting creation of a new contact, in accordance with some embodiments of the present invention;

FIG. 31 is an exemplary GUI screen presenting groups list, in accordance with some embodiments of the present invention;

FIG. 32 is an exemplary GUI screen presenting creation of a new group, in accordance with some embodiments of the present invention; and

FIG. 33, which is an exemplary GUI screen presenting a group hub, in accordance with some embodiments of the present invention.

### DESCRIPTION OF SPECIFIC EMBODIMENTS OF THE INVENTION

The present invention, in some embodiments thereof, relates to graphical user interfaces and, more specifically, but not exclusively, to graphical user interfaces designed to schedule meetings.

As used herein, the term GUI may refer to code associated with the GUI, which is executed by the processor(s) to perform background processing, for example, computation of the time slots and/or locations based on weights and/or ranking scores, as described herein.

As used herein, features described with reference to events may be implemented with reference to meetings. As used herein, features described with reference to meetings may be implemented with reference to events.

As used herein, the term time slot may refer to the time and/or date of the meeting and/or event.

An aspect of some embodiments of the present invention relates to systems, methods, an apparatus, and/or code instructions (e.g., stored in a data storage device, executable by hardware processor(s)) for using a GUI for scheduling a meeting. The GUI presents a list of user credentials, which represent candidates for attending the meeting, for example, a list of stored contract. The GUI presents a priority scale having regions indicative of relative priority for attendance. For example, one end of the scale denotes not required, the other end of the scale denotes must attend, and regions between denote relative important in attendance. The priority scale may be divided into regions arranged along the priority scale. All user credentials within the same region may have the same priority, regardless of relative location within the region. Alternatively, location within the region denotes a sub-ranking within the region. Alternatively, the priority scale is continuous without regions, where relative locations along the scale denote relative importance in attendance. A gesture performed by the user via the GUI is identified. The gesture (e.g., maneuvering by a finger contacting the touch screen, click and drop using a mouse, voice command) is for navigating a set of the user credentials from the list into respective regions within the priority scale. An invitation including time slots and locations each associated with a relative ranking score is sent to each one of the set of user credentials that were selected (e.g., located in the priority scale). The time slots and/or locations are options for selections. The time slots and/or locations and/or relative ranking scores may be manually selected via the GUI and/or automatically computed by a classifier as described herein. Multiple responses are received from the invited user credentials. Each response is associated with relative response ranking score denoting relative preference, and a participation score indicative of likelihood of participation by the respective user credentials in attending each respective time slot, and each respective location. The participation score may be categorical (e.g., yes, no, maybe, likely to attend, might not make it), and/or continuous (e.g., probability score indicative of likelihood of attendance). The relative response ranking score and/or participation scores are selected by the respective user credential and/or automatically computed by the classifier for each respective user credential. Optimal time slots and optimal locations are computed by aggregating all of the responses in view of the selections by the current user using the GUI. The computational is by weighting the relative response ranking scores and participation scores for each of the time slots and each of the locations received from each invited user credentials, according to the region of the respective user credentials within the priority scale and according to the relative ranking score assigned to each time slot and each location by the current user using the GUI, for example, by brute force methods that try every possible combination, and/or by heuristic methods, and/or by minimizing a loss function, and/or by a trained machine learning process as described herein. The preferences for time slots and/or locations of user credentials located relatively higher in the priority scale are assigned greater weight than preferences for time slots and/or locations of user credentials located relatively lower in the priority scale. A single time slot and a single location are selected by the user from the computed optimal time slots and optimal locations and a final invitation is sent to each one of the set of user credentials that were selected. Multiple responses are received from the invited user credentials. Each response may categorially represent the likelihood of attendance of the meeting at the selected single time slot and single location (e.g., yes, no, maybe). In another implementation, the response provides a numerical value (e.g., percentage) and/or a location within a range (e.g., the user slides a bar within the defined range) to indicate likelihood of attendance. Color coding indicative of likelihood of attendance of the meeting scheduled at the single time slot and the single location by each of the user credentials may be presented in the GUI. For example, Red denotes low likelihood of attendance, green denotes high likelihood of attendance, and yellow denotes mid-range likelihood of attendance.

Optionally, the time slots, the locations, and the associated relative ranking scores are automatically computed by a classifier based on an analysis of a future meeting dataset of a current user organizing the meeting (indicative of future availability), and based on an analysis of a historical meeting dataset of the current user storing historical scheduled time slots, historical locations, and historical associated relative ranking scores (indicating historical preferences). The responses from the invited user credentials are computed by the classifier based on an analysis of a future meeting dataset of each respective user credentials invited to meeting (indicative of future availability), and based on an analysis of a historical meeting dataset of the respective user credentials storing historical scheduled time slots, historical locations, and historical associated relative ranking scores (indicative of historical preferences). The automated method may be fully automated for selection of the single time slot and the single location for the meeting based on future availability of the invitees and current user (organizing the meeting) and past historical preferences of the invitees and current user.

Optionally, the time slots are based on preferences selected by the organizing user (e.g. meeting duration and time frame) and responses from the invited user credentials, which may be manually selected via the GUI and/or computed by the classifier based on an analysis of the calendars of the invited users, and on a future meeting dataset of each respective user credentials invited to meeting (indicative of future availability).

Optionally, the list of user credentials presented within the GUI for attending the meeting includes multiple predefined groups. Each group includes a set of preselected user credentials as members. The user may maneuver (via the GUI) one or more groups from the list into the priority scale. In this manner, the user may invite the group as a whole to the meeting. The single time slot and single location may be presented within a group calendar in the GUI. The group calendar presents a summary of scheduled meetings for the predefined groups. The calendar may be interactive and/or searched and/or adjusted, for example, to present scheduled meetings for selected groups.

Optionally, a group hub is presented within the GUI in response to selection of one of the defined groups, for example, by clicking on the name of the group. The group hub may include one or more of the following features: a group chat GUI for interactive communication between user credentials of the selected group, a group content feature for posting content (e.g., messages, files) and viewing the posted content within the GUI between the user credentials of the selected group, an upcoming meeting and/or event feature for viewing within the GUI upcoming scheduled meetings and/or events including the selected group, a create meeting and/or event feature for creating new meetings and/or events for the selected group via the GUI, a reminder of meeting and/or event feature for creating custom reminders for upcoming scheduled meetings and/or events for transmission to client terminals of the user credentials of the selected group, a view group calendar feature for presenting within the GUI a calendar including upcoming scheduled meetings and/or events, folders each storing previously posted content and/or chats and/or content for viewing within the GUI, a group log storing a list of activities of the one group for viewing the GUI, a group report feature for producing an ongoing updated custom report that present the group data for sharing with the user credentials of the selected group or printing.

An aspect of some embodiments of the present invention relates to systems, methods, an apparatus, and/or code instructions (e.g., stored in a data storage device, executable by hardware processor(s)) for using a graphical user interface (GUI) designed for scheduling an event. A list of user credentials for attending the event, are presented within the GUI. A priority scale having regions indicative of relative priority for attendance is presented within the GUI. A gesture performed via the GUI, for navigating a set of the user credentials from the list into respective regions within the priority scale is identified. An invitation is sent to each one of the set of user credentials. The invitation includes a single selected time slot and a single selected location. The single time slot and single location may be selected, for example, by a user manually entering the time slot and location, and/or by code that automatically analyzes past attendance patterns of the user credentials and/or code that automatically analyzes availability of the user credentials (e.g., based on other scheduled events and/or meetings such as in a calendar), for example, as described herein. Multiple responses to the invitations are received. Each response is indicative of acceptance or decline of the invitation by the respective user credentials, i.e. whether the respective user credential will be participating in the event or not. Color coding indicative of attendance or no-attendance of the event by each of the of user credentials is presented within the priority scale of the GUI.

Optionally, the event and/or meeting is a current occurrence of a recurring event and/or meeting, associated with one or more previous occurrences. For example, an annual conference. The list of user credentials presented within the GUI for selection thereof for attending the event and/or meeting may include user credentials that attended one or more of the previous occurrences of the event and/or meeting. A summary for each previous occurrence of the recurring event and/or meeting may be presented within the GUI, for example, accessible via a selection of an element (e.g., icon, link). The event and/or meeting summary includes multiple fields, for example, one or more of: invited user credentials, participating user credentials, key event and/or meeting details, event and/or meeting conclusion, and recommendations for following event and/or meetings. The event and/or meeting summary presents experiences from past occurrences of event and/or meetings in a convenient and/or manageable way to provide easy access to all the required data in order to organize a better and more cost-efficient event and/or meeting. Once the current occurrence of the event and/or meeting has terminated, in response to an indication of the termination (e.g., after the date of the current occurrence has passed, after the organizer clicks an icon in the GUI denoting termination, after a message is transmitted), an event and/or meeting feedback form including the fields may be automatically generated and transmitted to the user credentials. The user credentials may be those invited and/or attending the event and/or meeting. Multiple replies are received in response to the forms. The replies include values for the fields of the forms. The values of the fields from the replies are aggregated to generate a summary for the current occurrence. The new summary is made available within the GUI, for example, for assistance in planning future occurrences of the recurring event and/or meeting.

An aspect of some embodiments of the present invention relates to systems, methods, an apparatus, and/or code instructions (e.g., stored in a data storage device, executable by hardware processor(s)) for managing groups attending an event and/or meeting. The GUI includes one or more elements for selection thereof that trigger different features related to management of groups. In response to a first selection, predefined groups of user credentials are presented within the GUI. The predefined groups are for selection for participation in a scheduled meeting and/or event. In response to a second selection, a summary of scheduled meetings and/or events for the predefined groups is presented within an interactive calendar in the GUI. The interactive calendar is responsive to selection of a certain predefined group and/or certain scheduled meeting and/or certain scheduled event for editing thereof by a user, for example, as described herein. In response to a third selection of one group of the predefined groups, a group hub is presented within the GUI. The group hub includes one or more of the following exemplary features: a group chat GUI for interactive communication between user credentials of the one group, a group content feature for posting content and viewing the posted content within the GUI between the user credentials of the one group, an upcoming meeting and/or event feature for viewing within the GUI upcoming scheduled meetings and/or events including the one group, a create meeting and/or event feature for creating new meetings and/or events for the one group via the GUI, a reminder of meeting and/or event feature for creating custom reminders for upcoming scheduled meeting and/or event for transmission to client terminals of the plurality of user credentials of the one group, a view group calendar feature for presenting within the GUI a calendar including upcoming scheduled meetings and/or events, folders each storing previously posted content and/or chats and/or content for viewing within the GUI, a group log storing a list of activities of the one group for viewing the GUI, a group report feature for producing a custom report that present the group data for sharing with the user credentials of the selected group or printing.

The GUI described herein may be implemented as code stored in a memory for execution by one or more hardware processors. The GUI may be centrally stored, for example, by a network connected server for remote access by client terminals (e.g., via web browsers). In another exemplary implementation, the GUI may be provided as an application for local download to a client terminal (e.g., mobile device, laptop computer, desktop computer).

The GUI is specifically designed to improve speed and/or efficiency of organizing a meeting. The priority scale and the list of candidate user credentials are designed for quickly selecting user credentials to invite to the meeting, quickly assigning relative priority to the selected users in attending the meeting, and the color coded presentation within the priority scale summarizes likelihood of the invited user credentials in attending meeting at the selected single time slot and single location.

The GUI described herein is designed to provide a simple, quick and convenient way to manage the user's schedule. Especially all the user's multi-participant meetings, events, either in recurring groups or on a one event and/or one meeting base. The GUI is designed to enable the user to maximize efficiency, by removing the complexity of planning and coordinating multi-participants' meetings and events, taking in consideration various parameters including the participant's priorities, optional times and locations, and allowing user to schedule meetings and events with colleagues and friends in just a few simple steps. The GUI serves as a middle-man between people, groups and organizations by handling all the heavy lifting of meetings and events coordination, between all participants (i.e., via user credentials of the participants), which are usually big time consuming.

To properly execute a meeting, it requires multiple working figures and processes, for example, one or more of: Inviting each selected user credential to respond with a participation score indicative of participation at each provided time slot and each location. Collecting responses from the invited user credentials. Processing and reviewing the data. Computing optimal time slots and optimal locations by weighting the participation scores for each respective time slot and each respective of each response according to the location of the respective user credentials on the priority scale and according to the relative ranking score. Selecting a single time slot and a single location by the user and sending a final invitation. Verifying with the invited user credentials the selected time and/or location and adjusting in case there is an error or change

At least some of the implementations of the GUI described herein address the technical problem of taking into consideration all the parameters and priorities of all invited user credentials and the organizer credentials and using them to calculate a single time and location, which is most optimal for all invited user credentials, which is an overwhelming task if attempted to be performed manually. The GUI described herein may use machine learning processes designed to automatically deduce optimal meeting options while taking into consideration the priority and preferences of the invited user credentials and the organizer credentials, therefore allowing for more efficient utilizing of manpower and saves countless of working hours.

Executing recurring events properly requires taking into consideration multiple factors: Managing lists of invited user credentials and participants from previous events. Reviewing key details that were discussed during past events. Managing recommendations and assignments from occurred events. Communicating with participants of previous events.

Coordinators may conduct recurring events, but they encounter difficulties doing so, since experiences from past events are not stored in a convenient and manageable way to provide easy access to all the required data in order to organize a better and more cost-efficient meeting.

The GUI described herein provides a simple solution for all these problems in the form of an accessible interface and allows for simple event management while integrating all the listed planning processes.

The GUI is designed practically for wide population, from people who want to manage their meetings and events more efficiently, to large corporations which have large multiple staff meetings and events, thus managing a task such as scheduling a meeting that is fit for all can be a chore. The GUI is designed to be very intuitive and easy to use, which makes learning the software and its multiple features very simple.

The GUI is designed for aggregation and/or processing of user credential's priorities, which may provide for automatic optimization. When scheduling a meeting, the meeting organizer credential may define priorities of 3 types: (i) Invitees (referred to herein as user credentials)—placing the user credentials in a priority list, implying that replies and suggestions of user credentials that are listed higher on the list will have a heavier weight in the calculation of the finalized meeting. (ii) Time—After the organizer has picked optional time slots, the organizer may assign a relative ranking score for each slot individually regarding preferences and as a result, the GUI integrates the higher rated time slots first. (iii) Location—The organizer provides several optional locations for the meeting and may assign a relative ranking score for each location regarding preference and the GUI selects the final meeting location as the highest scoring location among all user credentials.

After completion of initial meeting arrangement, invitations are sent to all selected user credentials. Upon receipt, user credentials may prioritize time slots and locations by a participation score indicative of likelihood of attendance for each option individually and may also suggest their own, more viable, options to the organizer (when the organizer allowed so). In addition, all replies to the meeting options (time & location), for example, with one of 3 available options (“yes”, “no” and “maybe”) stating their position regarding the provided option. The maybe option may be provided as a probability score and/or range indicative of likelihood of attendance, where yes denotes 100% and no denotes 0%.

Data from user credentials may be processed (e.g., continuously, as received, and/or after a time interval has elapsed) in order to automatically determine optimal time slots and/or locations for the meeting, taking in account the relative ranking scores defined by the meeting organizer, priority scale locations for each of the user credentials, and then the various participation scores of responding user credentials regarding the time and/or location of the meeting.

The various replies and/or participation scores are weighted and/or calculated based on the location of user credentials along the priority scale as pre-defined by the organizers (i.e., user credentials who are listed higher on the priority list have a heavier weight in the calculation of the selected time slot and location—their participation scores have a higher score, than user credentials that are listed lower).

The organizing user selects a single time slot and a single location and sends a final invitation to the user credentials, which reply to the final invitation, for example, with one of 3 available options (“yes”, “no” and “maybe”), a numerical value (e.g., percentage), and/or relative location within a range, stating their position regarding the selected option.

Optionally, the GUI is designed to provide fully automatic scheduling solutions and/or functionalities. The GUI may automatically calculate optimal time frames for a meeting based on the organizer's request, using the auto-picker function. The auto-picker selects the candidate time slots with highest relative ranking scores and/or participation scores among all the suggestions and/or checks availability of the time slot in the calendars of the user credentials (including the organizer). When a certain candidate time slot is available then the time is set, otherwise the next time slot (based on relative ranking score and/or participation score) is checked. When no available time slots are found among the suggestions of the responding user credentials, the GUI finds the nearest available time slot for the meeting for all user credentials. The GUI may select an optimal time frame for a meeting based on organizers credentials and/or user credentials schedules without the need to suggest time slot options at all. In addition, the GUI may integrate into existing calendars of both user credentials and the organizer credential automatically.

Optionally, the GUI is designed to provide automatic scheduling solutions and/or functionalities. The auto-picker option is designed to allow the user to define preferences for calculating the time slots (e.g., meeting duration and/or time frame), during a preferred period that the user may identify. The user credentials responses may be computed by the classifier based on the user preferences, analysis of the calendar of the user, and/or analysis of a future meeting dataset of each respective user credentials invited to meeting (i.e., indicative of future availability).

The user credentials can select to have ‘manual response’ in which the response is manually selected within the user preferences via the GUI.

Optionally, the GUI is designed to provide group scheduling solutions. The GUI may operate on a hierarchy type management system for groups and large organizations. The user may create groups for various projects and/or occasions and monitor their synchronization on a broad group calendar presented in the GUI. The design allows the user to track collisions and meeting schedules of any number of groups while maintaining the ability to nitpick each group and edit its schedules individually. Each group has various functionalities such as group hubs where users may chat and exchange files, it is also possible to make recurring group meetings and create predefined group contacts to ease scheduling new meetings.

At least some of the systems and/or methods described herein address the technical problem of scheduling and managing multi-participant meetings, events, either in recurring groups or on a one event and/or one meeting base, which is a tedious and repetitive task. Organizers must manually communicate with each meeting participant, acquiring best possible time frames and locations in order to deduce the best meeting time and location, all while considering the importance of attendance of participants.

The aggregation of various meeting parameters for potential attendees is complex, and makes it difficult, and at times even impossible, for a meeting coordinator to present an optimal time and location solutions fit for all.

Furthermore, large and small organizations struggle with group planning solutions. Planning recurring team meetings, scheduling group meetings while monitoring the presence of all the group members and lack of a unique group calendar to manage group events can hurt the growth and communication of the organization.

At least some of the systems and/or methods described herein relate to a technical solution for individuals and/or companies alike in the form of optimizing meetings coordination and time management. The achieved value comprises from the ability of the GUI to efficiently utilize time and replace the functionality of a meeting coordinator, thus saving on manpower expenses.

The technical solution provided by the GUI described herein provides one or more robust and/or advanced machine learning processes which are able to independently deduce optimal time options for meetings and provide with compatible scheduling tools and means of data transfer for meetings and events.

It may be possible to trace the benefits of the GUI by executing statistical analysis of meeting diaries and conducting surveys regarding meeting occurrence and time utilization, in order to receive better understanding of the technical solution that is provided by the invention.

At least some of the systems and/or methods described herein improve the technology of GUIs by a design for quickly (i.e., with minimal user actions) assigning ranking scores to user credentials and/or time slots and/or locations (which may be provided by the organizer credentials and/or suggested by invited user credentials). The GUI includes code for automatically predispose optimal meeting decision considering all the listed factors. Moreover, the GUI provides code for a fully automatic approach used in providing viable time slots with the auto-picker and the automatic decision making when calculating a final time slot and location for a meeting. The GUI provides an innovative framework for managing groups and includes a group calendars and hubs that provides an accessible interface for integrating with groups and large organizations.

At least some of the systems and/or methods described herein improve the technology of GUIs by a design for prioritizing user credentials (i.e., attendees) by navigating the user credentials to target locations within the priority scale, thus determining which requests are more likely to be taken into consideration (i.e., assigned relatively higher weights) when selecting the single time and single location. Furthermore, the GUI is designed to use and aggregates the priority scale regarding the selected user credentials themselves and may deduce optimal meeting decisions while considering all the underlying factors completely automatically.

At least in some implementations, the GUI is designed to provide procedurally generated time and location solutions for meetings without human intervention with the auto-picker feature which is capable of automatically distinguishing available time slots for scheduling meetings and events and eventually providing time slots to address the user credentials.

At least in some implementations, the GUI is designed for providing innovative scheduling functionalities for groups and large organizations: group hubs for providing user credentials with the relevant meeting information and files, recurring group meetings and events, predefined group contacts that can be used as an existing entity in order ease scheduling new group meetings and unique group calendars that provide accessible interface when interacting and managing group meetings and events.

At least some of the systems and/or methods described herein provides technical solutions, besides a convenient way of schedule management, in the forms of: time slot and location prioritization options for user credentials, automated time picking option for meetings with the auto-picker functionality, and scheduling solutions for group meetings and events in the form of an accessible GUI for convenient group management.

Aggregating participant priorities and preferences cannot be performed by a human, so constructing an automated process to do the task requires immense logical and practical knowledge in the field of machine learning. Such process has no manual counterpart, since due to the large number of possible combinations, which increases greatly at the number of participants increases, a human cannot evaluation all options to select the best time and/or location. Automatizing the scheduling process with the auto-picker functionality is unintuitive, since it is more common for the Coordinator and the attendees to pick a time for the meeting themselves. The group scheduling functionality provided by the GUI is comprised from layers of management functionalities and coordination between multiple entities which cannot be deduced from the provided problem.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

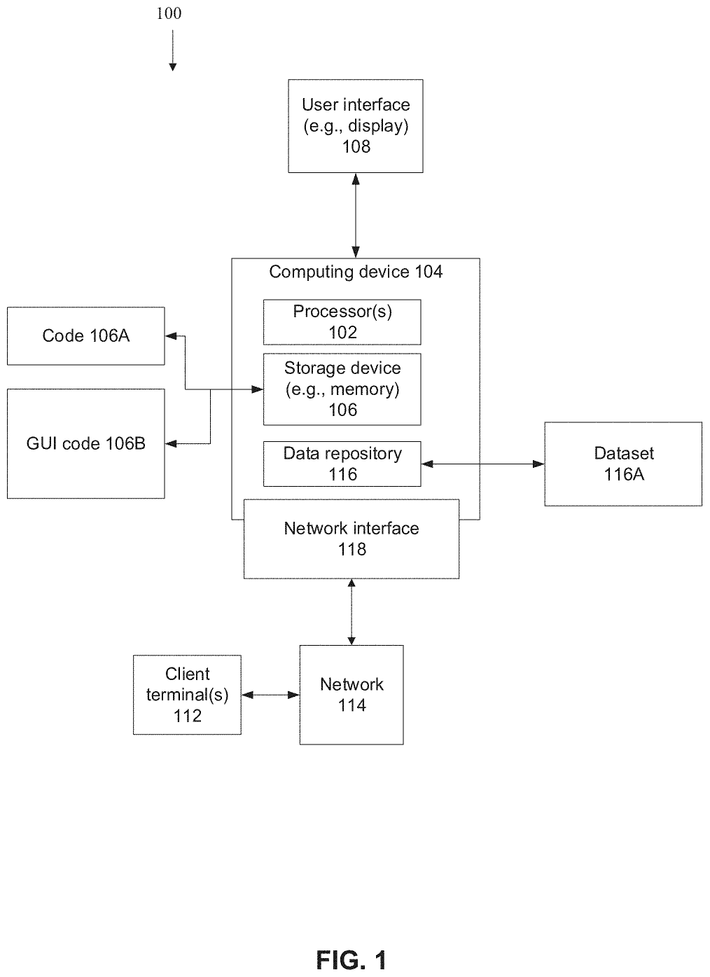

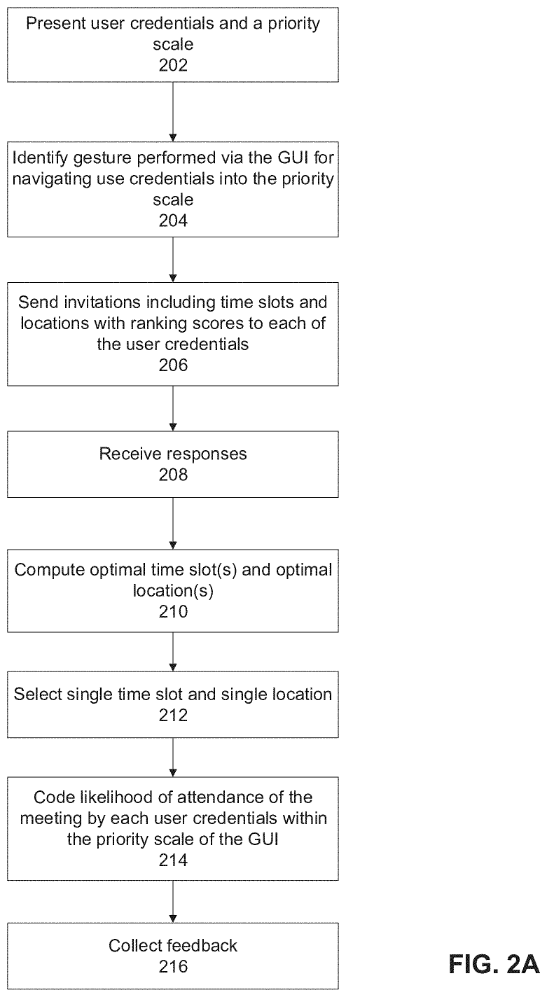

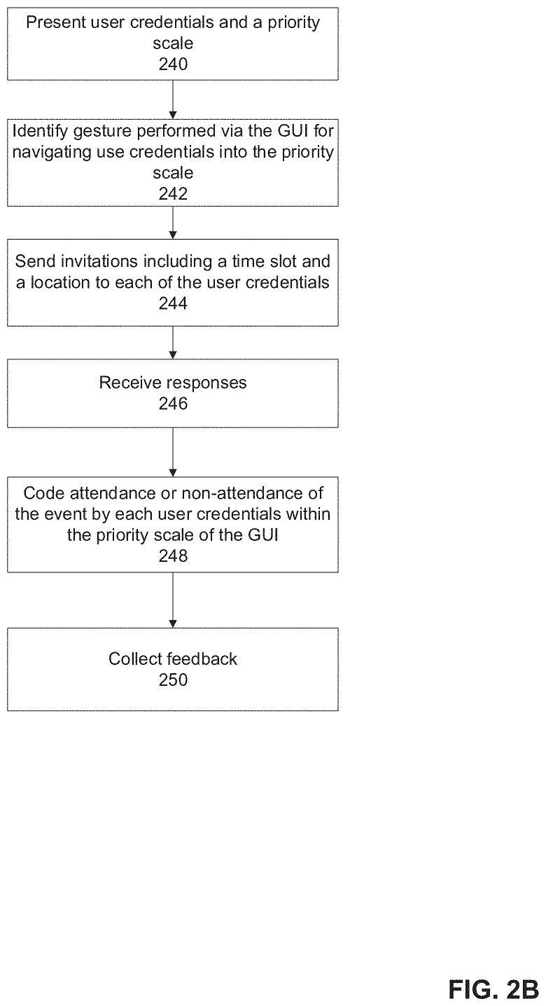

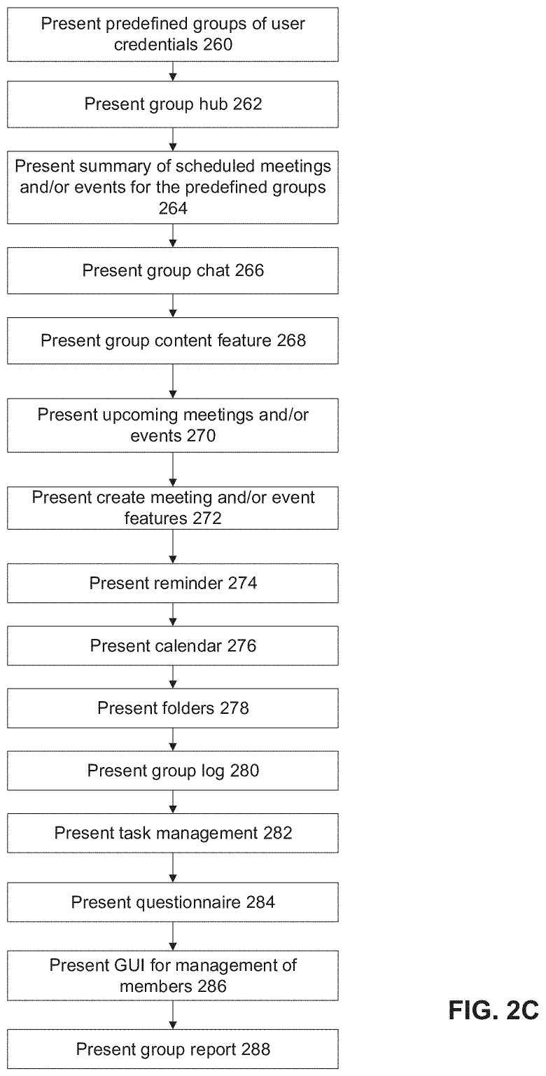

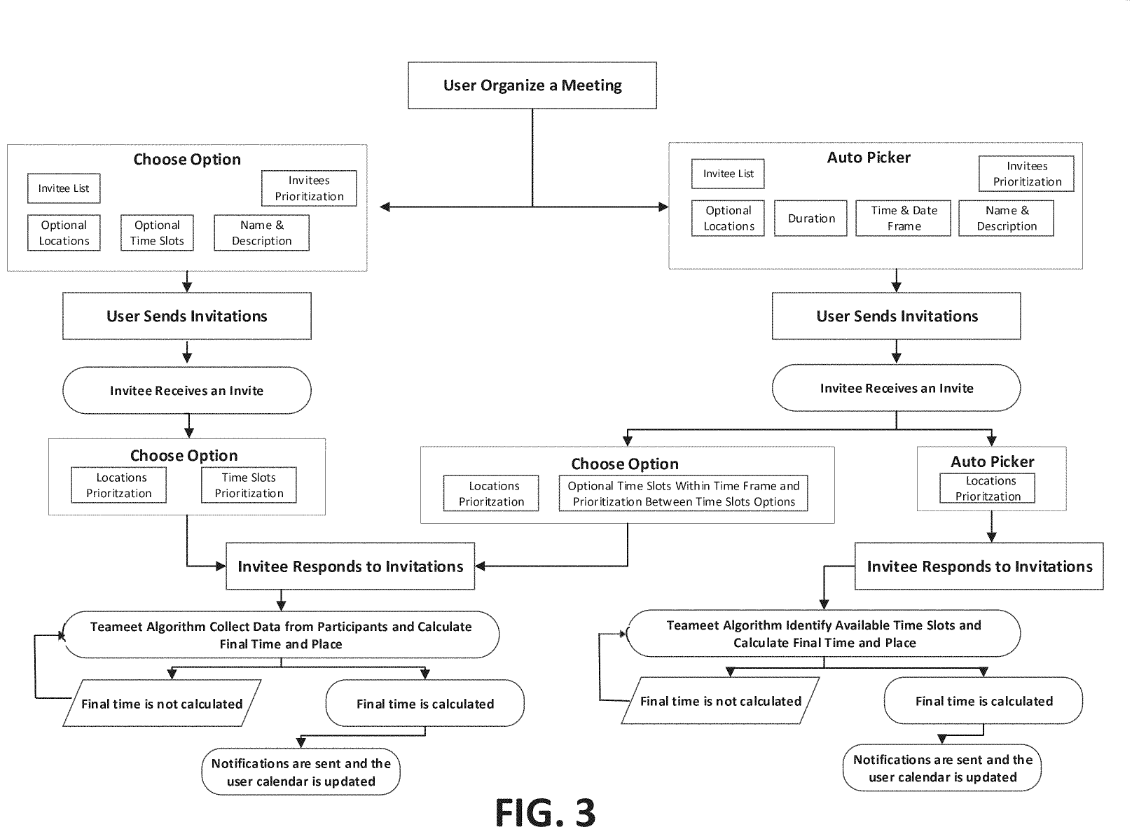

Reference is now made to FIG. 1, which is a block diagram of components of a system 100 for creating a meeting and/or creating an event and/or managing groups, by a GUI, in accordance with some embodiments of the present invention. Reference is also made to FIG. 2A, which is a flowchart of a process for creating a meeting by a GUI, in accordance with some embodiments of the present invention. Reference is also made to FIG. 2B, which is a flowchart of a process for creating an event by a GUI, in accordance with some embodiments of the present invention. Reference is also made to FIG. 2C, which is a flowchart of a process for managing groups, by a GUI, in accordance with some embodiments of the present invention. It is noted that features described with reference each of FIGS. 2A-C may be implemented independently and/or in parallel to the features described with reference to the other FIGS. 2A-C. For example, the user may create a meeting based on FIG. 2A and/or create an event based on FIG. 2B, and in parallel manage groups based on FIG. 2C. Features described with reference to FIGS. 3-33 may be implemented by components of system 100. Features described with reference to FIGS. 2A-C may be implemented by and/or combined with features described with reference to FIGS. 3-33. Features described with reference to FIGS. 3-33 may provide additional details to the features described with reference to FIGS. 2A-C.

System 100 may implement the acts of the method described with reference to FIGS. 2A-C (and/or other FIGs. described herein), by processor(s) 102 of a computing device 104 executing code instructions 106A and/or 106B stored in a storage device 106 (also referred to as a memory and/or program store).

Computing device 104 and/or client terminals(s) 112 may be implemented as, for example, a client terminal, a server, a computing cloud, a virtual server, a virtual machine, a mobile device, a desktop computer, a thin client, a Smartphone, a Tablet computer, a laptop computer, a wearable computer, glasses computer, and a watch computer.

Multiple architectures of system 100 based on computing device 104 may be implemented. In an exemplary implementation, computing device 104 storing code 106A and/or 106B, may be implemented as one or more servers (e.g., network server, web server, a computing cloud, a virtual server) that provides services (e.g., one or more of the acts described with reference to FIGS. 2A-C and other FIGs. described herein) to one or more client terminals 112 over a network 114, for example, providing software as a service (SaaS) to the client terminal(s) 112, providing software services accessible using a software interface (e.g., application programming interface (API), software development kit (SDK)), providing an application for local download to the client terminal(s) 112, and/or providing functions using a remote access session to the client terminals 112, such as through a web browser. For example, users use client terminals 112 to access computing device 104, which may be remotely located, for accessing the GUI to create the meeting, create the event, and/or manage groups attending the events and/or meetings. In another example, computing device 104 may include locally stored software (e.g., code 106A and/or 106B) that performs one or more of the acts described with reference to FIG. 1, for example, as a self-contained client terminal. For example, the GUI is locally stored and run on a mobile device. In another example, client terminals 112 may obtain GUI code 106B from computing device 104 for local installation and use (e.g., installed as an app on a mobile device). Processor(s) 102 of computing device 104 may be implemented, for example, as a central processing unit(s) (CPU), a graphics processing unit(s) (GPU), field programmable gate array(s) (FPGA), digital signal processor(s) (DSP), and application specific integrated circuit(s) (ASIC). Processor(s) 102 may include a single processor, or multiple processors (homogenous or heterogeneous) arranged for parallel processing, as clusters and/or as one or more multi core processing devices.

Data storage device 106 stores code instructions executable by processor(s) 102, for example, a random access memory (RAM), read-only memory (ROM), and/or a storage device, for example, non-volatile memory, magnetic media, semiconductor memory devices, hard drive, removable storage, and optical media (e.g., DVD, CD-ROM). Storage device 106 stores code 106A that implements one or more features and/or acts of the method described with reference to FIGS. 2A-C and/or other FIGs. when executed by processor(s) 102. Storage device 106 may store GUI code 106B that implements the GUI described herein.

Computing device 104 may include a data repository 116 for storing dataset 116A, for example, historical data of who attended which event and/or meeting, responses from invitees to the meeting, and/or data of scheduled future meetings and/or events, as described herein. Data repository 116 may be implemented as, for example, a memory, a local hard-drive, virtual storage, a removable storage unit, an optical disk, a storage device, and/or as a remote server and/or computing cloud (e.g., accessed using a network connection).

Network 114 may be implemented as, for example, the internet, a local area network, a virtual private network, a wireless network, a cellular network, a local bus, a point to point link (e.g., wired), and/or combinations of the aforementioned.

Computing device 104 may include a network interface 118 for connecting to network 114, for example, one or more of, a network interface card, a wireless interface to connect to a wireless network, a physical interface for connecting to a cable for network connectivity, a virtual interface implemented in software, network communication software providing higher layers of network connectivity, and/or other implementations. Computing device 104 may connect using network 114 (or another communication channel, such as through a direct link (e.g., cable, wireless) and/or indirect link (e.g., via an intermediary computing unit such as a server, and/or via a storage device) with client terminals 112.

Computing device 104 and/or client terminal(s) 112 include and/or are in communication with one or more physical user interfaces 108 that include a mechanism for a user to enter data into the GUI and/or view the GUI. Exemplary user interfaces 108 include, for example, one or more of, a touchscreen, a display, a keyboard, a mouse, and voice activated software using speakers and microphone.

Referring now back to FIG. 2A, at 202, a list of user credentials for attending the meeting, and a priority scale having regions indicative of relative priority for attendance, are presented within the GUI.

The list set of user credentials for attending the meeting and/or event may include predefined groups of user credentials.

The user credentials may be manually entered by the user and/or selected from previously defined user credentials, and/or automatically extracted by code (e.g., from contacts of the user).

At 204, a gesture performed via the GUI, for navigating a set of the user credentials from the list into respective regions within the priority scale, is identified.

The gesture may be, for example, maneuvering by a finger contacting the touch screen, click and drop using a mouse, and/or a voice command.

At 206, an invitation including time slots and locations, each associated with a relative ranking score, are sent to each one of the set of user credentials. For example, an email message is sent to an email defined by the user credentials, a pop-up push message and/or other message is sent to a phone number defined by the use credentials, and/or another message format is sent to an application for access by the user according to an address defined by the user credentials (e.g., user name on a social network platform).

The time slots, the locations, and associated relative ranking scores may be automatically computed by a classifier (e.g., machine learning model, neural network, Markov chains, support vector machine (SVM), logistic regression, k-nearest neighbor, decision trees, and sets of rules) based on an analysis of the users' calendar, and a future meeting dataset of a current user organizing the meeting.

Optionally, the machine learning model (and/or other classifier implementation) is fed additional data, for example, an indication of gestures when using the GUI performed by the user setting up the meeting, and/or by the responding users. The gestures may be the gestures when using the GUI to set the relative ranking scores and/or select the time slots and/or locations. The gestures may help predict accuracy of the results, for example, by providing an indication of confidence of the user in their own provided data. In another example, the additional data includes geographical locations, such as current and/or future locations of the user setting up the meeting, and/or of the responding users. For example, obtained from a GPS device, and/or obtained from a navigation application such as when the user is driving to determine the planned route of the user.

The classifier may be trained, for example, on a training dataset of time slots, locations, and associated relative ranking scores, and a ground truth of the historical meetings that were designated and an indication of attendance at the meeting. The additional data, such as historical gestures (of one or more sessions of using the GUI) and/or current and/or future geographical locations may be fed into the classifier for training thereof. The classifier may be dynamically trained, by being fed the actual real data entered by the users organizing the meetings and/or events, the received responses, and the actual set meeting time slots and/or locations, and the actual attendance at the meeting. The classifier may be centrally and dynamically updated, by being fed data from multiple different users using the GUI. The classifier may include one or more components. For example, one component that predicts time slots and/or locations for the meeting that the invited user credentials are likely to attend, for example, using a machine learning model. Another component, which may be integrated with the first component or be a separate component, analyzes the actual availability of the invited user credentials in order to optimize the available time slots and geographical locations, for example, using a scheduling optimization process.

At 208, responses to the sent invitations are received, through the system. The invited user may receive an email and/or other message, which may include a link to the system, for example, to the GUI. The invited user may receive the email and/or message even when the user is not subscribed.

Responses may be received as instructions generated by the user clicking on buttons in the invitation, and/or as other data. Each response is associated with relative response ranking score and a participation score indicative of likelihood of participation by the respective user credentials in attending each respective time slot, and each respective location.

The responses are provided by the responding users, for example, based on manual selection by each respective responding user, as described herein.

At 210, optimal time slot(s) and optimal location(s) are computed by weighting the relative response ranking scores and participation scores for the time slots and locations from the responses, according to the region of the respective user credentials within the priority scale and according to the relative ranking score assigned to each time slot and each location, by the organizing user.

The optimal time slots and optimal locations may be presented within a calendar in the GUI that presents a summary of scheduled meetings and/or events for the predefined groups.

At 212, a single time slot and a single location may be selected by the user from the computed optimal time slots and optimal locations. A final invitation may be sent to each one of the set of user credentials that were selected. Multiple responses may be received from the invited user credentials. Each response may categorially represent the likelihood of attendance of the meeting at the selected single time slot and single location (e.g., yes, no, maybe).

At 214, coding (e.g., using colors, size of fonts, type of font, bold, underline, italics, other effects) indicative of likelihood of attendance of the meeting scheduled at the single time slot and the single location by each of the user credentials is presented within the priority scale of the GUI.

At 216, feedback may be collected after a current occurrence of the recurring meeting. The meeting that is planned may be a current occurrence of a recurring meeting associated with at least one previous occurrence. In such a case, the list of user credentials for attending the meeting include user credentials that attended one or more previous occurrences.

Feedback may be collected by the following exemplary process: A summary for each previous occurrence of the recurring meeting is presented in the GUI. The meeting summary may include one or more of the following exemplary fields: invited user credentials, participating user credentials, key meeting details, meeting conclusion, and recommendations for following meeting. In response to an indication of termination of the current occurrence, a meeting feedback form including the fields may be selected. The meeting feedback form may be transmitted to the user credentials. Replies may be received. The values in the fields from the replies are aggregated to generate a summary for the current meeting.

Referring now back to FIG. 2B, at 240, a list of user credentials for attending the event, and a priority scale having regions indicative of relative priority for attendance, are presented within the GUI.

At 242, a gesture performed via the GUI, for navigating a set of the user credentials from the list into respective regions within the priority scale, is identified.

At 244, an invitation including a single selected time slot and a single selected location is sent to each one of the set of user credentials.

At 246, responses are received. Each response is indicative of acceptance or decline of the invitation by the respective user credentials.

At 248, coding (e.g., using colors, size of fonts, type of font, bold, underline, italics, other effects) indicative of attendance or no-attendance of the event by each of the user credentials is presented within the priority scale of the GUI.

At 250, feedback may be collected after a current occurrence of the recurring event. The event that is planned may be a current occurrence of a recurring event associated with at least one previous occurrence. In such a case, the list of user credentials for attending the event include user credentials that attended one or more previous occurrence.

Feedback may be collected by the following exemplary process: A summary for each previous occurrence of the recurring event, is presented in the GUI. The event summary may include one or more of the following exemplary fields: invited user credentials, participating user credentials, key event details, event conclusion, and recommendations for following events. In response to an indication of termination of the current occurrence, an event feedback form including the fields may be selected. The event feedback form may be transmitted to the user credentials. Replies may be received. The values in the fields from the replies are aggregated to generate a summary for the current occurrence.

Referring now back to FIG. 2C, at 260, predefined groups of user credentials are presented, for example, in response to a first selection (e.g., mouse click on an icon, touch of the icon via a touch screen, voice command).

The predefined groups may be presented, for example, when the user clicks on a ‘groups’ icon in the GUI.

The groups may be selected independently of the process of creating the meeting and/or event. For example, in the home screen of the GUI, the user may select one of three exemplary options: ‘Manage’, or ‘Groups’ or ‘Contacts’. The list of groups appears in response to selecting ‘Group’. The list of user credentials appears in response to selecting ‘Contacts’. Under ‘Manage’, the user may select one of three exemplary options: 1. Meetings sent (meeting the use organized); 2. Meeting received (meetings the user was invited to) and 3. Meetings Archive.

Alternatively or additionally, the predefined groups are presented within the GUI selected for the process of creating the meeting and/or event, as part of user credentials that may be selected to attend the meeting and/or event, as described herein.

At 262, a group hub is presented in the GUI. The group hub may be presented in response to selection of one group of the multiple predefined groups of user credentials associated with the user (e.g., created and/or defined by the user).

The group hub may be selected, for example, as an independent action (i.e., only select the group hub), selected in parallel to the process for creating the meeting (e.g. as described with reference to FIG. 2A) and/or in parallel to the process for creating the event (e.g. as described with reference to FIG. 2B), and/or triggered by a selection from within the process of creating the meeting and/or event (in which case the group hub may be implemented in parallel to the creation of the meeting and/or event), as described herein. For example, the group hub is presented for a group selected by the user from the list of user credentials presented in the GUI during the process of creating the meeting and/or event.

Features described with reference 264-288 represent different possible options that the user may select within the group hub. One or more of the features described with reference 264-288 may be selected, in no particular order. Additional details of the options are described herein.

At 264, a summary of scheduled meetings and/or events for the predefined groups, are presented within an interactive calendar in the GUI, as described herein. The interactive calendar is responsive to selection of a certain predefined group and/or certain scheduled meeting and/or certain scheduled event for editing thereof by a user.

At 266, a group chat GUI for interactive communication between multiple user credentials of the one group is presented in response to a selection, as described herein.

At 268, a group content feature for posting content and viewing the posted content within the GUI between the user credentials of the one group is presented in response to a selection, as described herein.

At 270, an upcoming meeting and/or event feature for viewing within the GUI upcoming scheduled meetings and/or events including the one group is presented in response to a selection, as described herein.

At 272, a create meeting and/or event feature for creating new meetings and/or event for the one group via the GUI is presented in response to a selection, as described herein. The meeting and/or events are created as described herein with reference to FIGS. 2A-2B and/or other FIGs.

At 274, a reminder of meeting and/or event feature for creating custom reminders for upcoming scheduled meetings and/or event for transmission to client terminals of the user credentials of the one group is presented in response to a selection, as described herein.

A 276, a view group calendar feature for presenting within the GUI a calendar including upcoming scheduled meetings and/or events is presented in response to a selection, as described herein.

At 278, folders each storing previously posted content and/or chats and/or content for viewing within the GUI are presented in response to a selection, as described herein.

At 280, a group log storing a list of activities of the one group for viewing the GUI is presented in response to a selection, as described herein.

At 282, a task management GUI is presented in response to a selection, as described herein.

At 284, a questionnaire GUI is presented in response to a selection, as described herein.

At 286, a GUI for management of the members of the group is presented in response to a selection, as described herein.

At 288, a group report GUI for creating reports from the group data and printing the report and/or sharing the report between user credentials of the one group is presented in response to a selection.

Reference is now made to FIG. 3, which is a flowchart of an exemplary process for using a GUI for selecting a time slot and location based on priority scale locations assigned to user credentials, ranking scores of time slots and locations, and participants, or for selecting the time slot based on the auto-picker option, and participation scores provided by user credentials responding to invitations to attend the meeting at the time slots and/or locations, in accordance with some embodiments of the present invention.

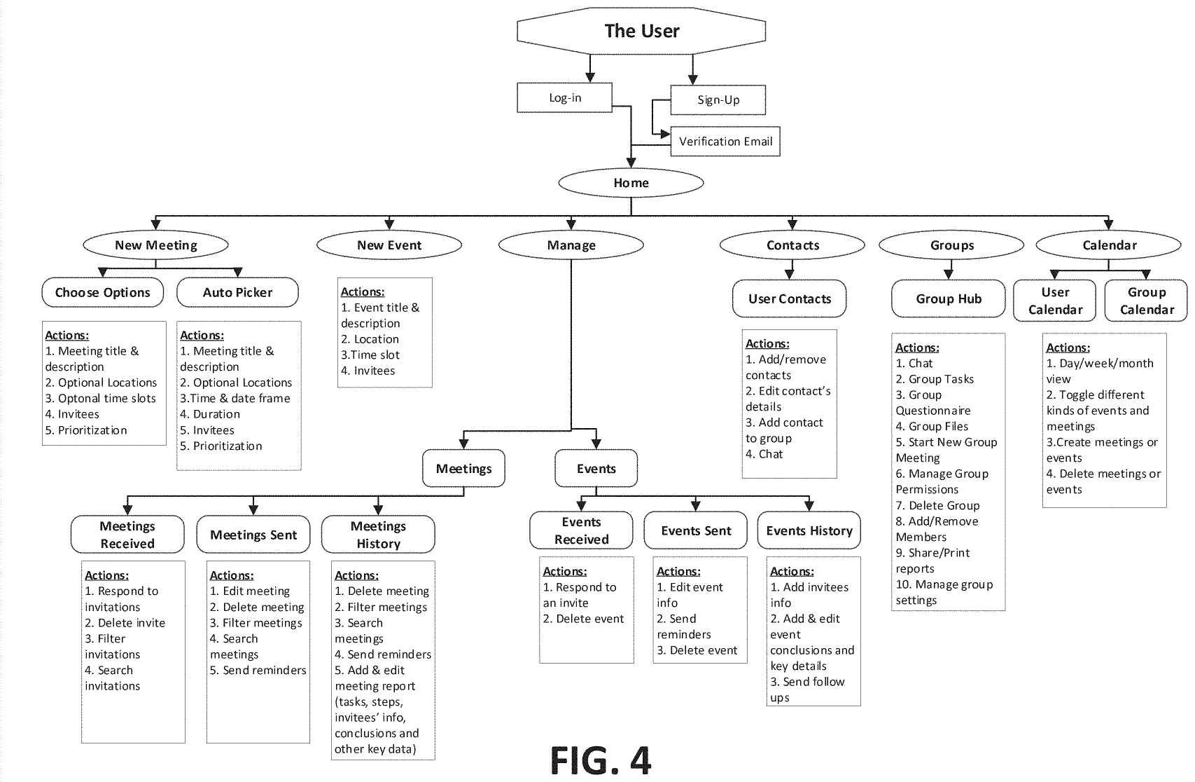

Reference is now made to FIG. 4, which is a flowchart of exemplary user experiences and actions provided by the GUI described herein, in accordance with some embodiments of the present invention. Details of the actions are described herein.

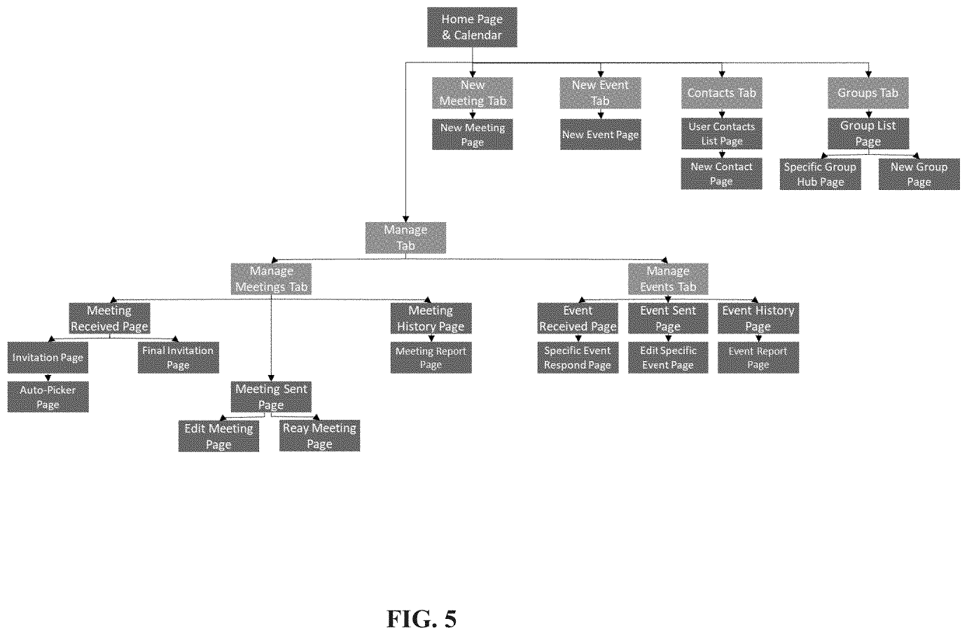

Reference is now made to FIG. 5, which is a flowchart of exemplary screen flows provided by the GUI described herein, in accordance with some embodiments of the present invention. Details of the screens are described herein.

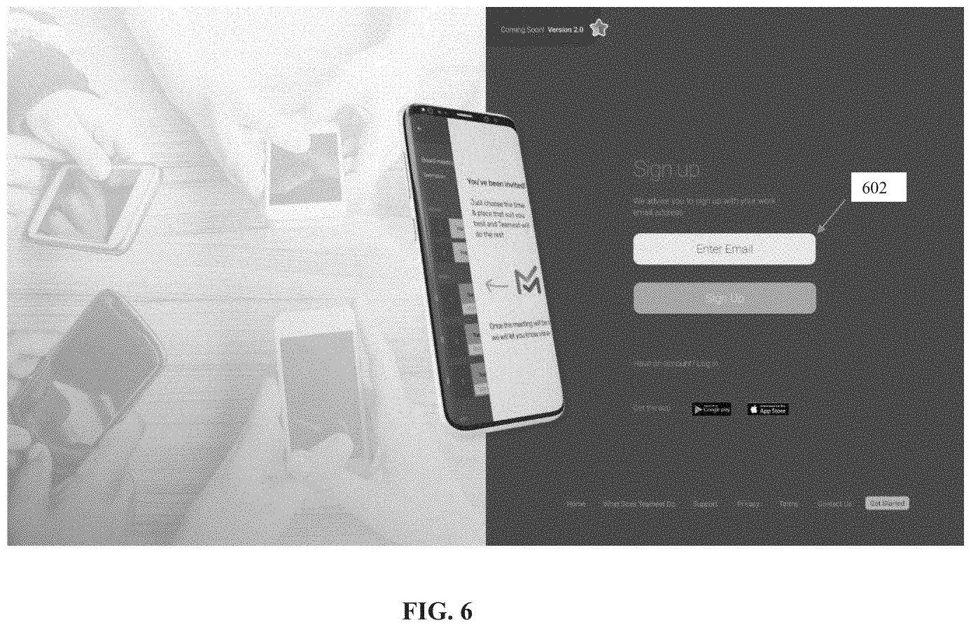

Reference is now made to FIG. 6, which is an exemplary screen of the GUI for registration, in accordance with some embodiments of the present invention.

When creating a new account for using the GUI described herein, each user is provided with user credentials (e.g., a valid email and a password, e.g., with a minimum of 7 digits) and adds them in the field 602 as shown in FIG. 6. After the user has entered all the required information the user may be obligated to review and accept the terms of service in order to be allowed to use the GUI.

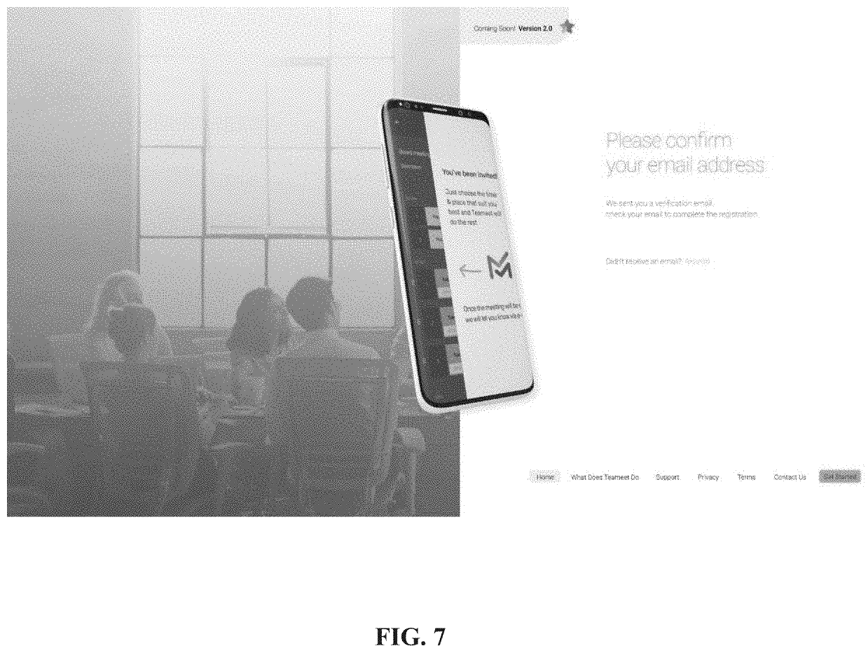

Reference is now made to FIG. 7, which is an exemplary screen shot of the GUI when the user clicks the create account button and a message indicating the near completion of the registration process pops up, in accordance with some embodiments of the present invention. The user is then sent a verification email in order to validate credibility which contains a link that completes the registration process and the user may proceed to log-in.

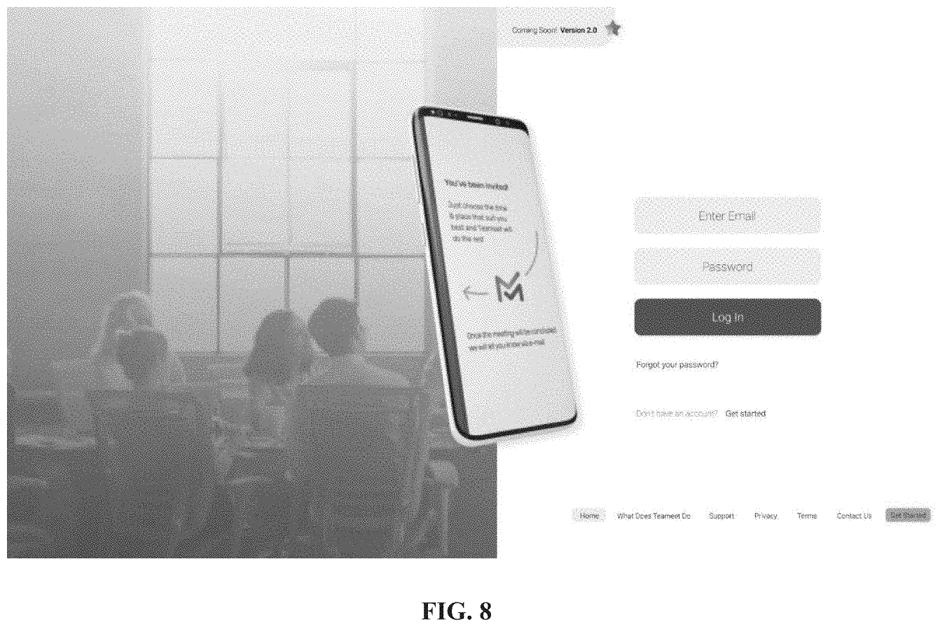

Reference is now made to FIG. 8, which is an exemplary screen of the GUI at log-in, when users of the GUI are required to provide their user credentials (e.g., Email) and password that they filled during registration, in accordance with some embodiments of the present invention.

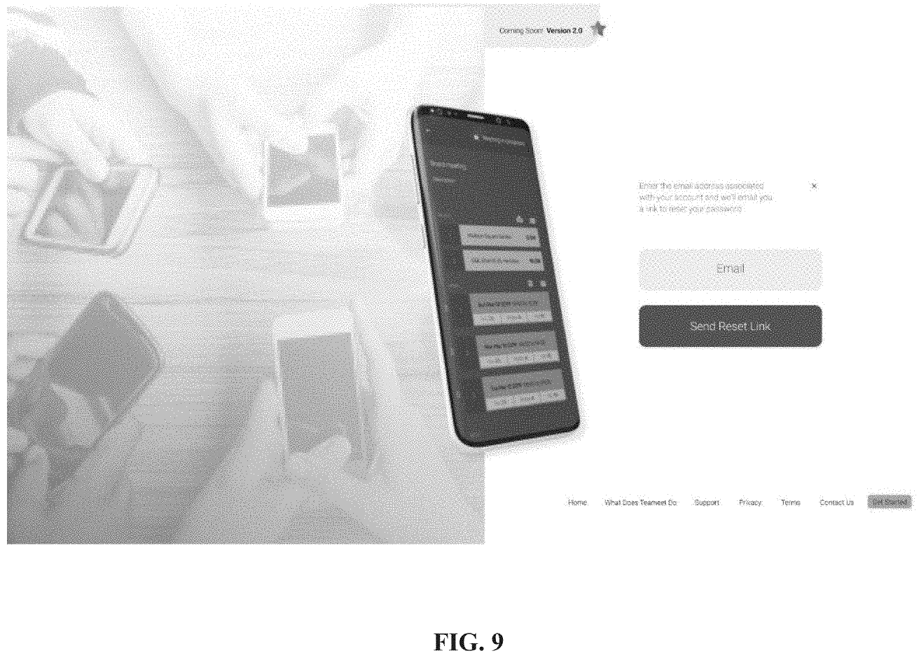

Reference is now made to FIG. 9, which is a screen shot of the GUI for password recovery where the user is required to provide the email used in registration, in accordance with some embodiments of the present invention. After the credentials have been verified the user may proceed to using the GUI.

An exemplary layout of the GUI is now described. It is understood that the layout may be adapted, for example, icons described as being on the left side may be presented on the right side. Some features are optional.

On the home page of the GUI, the user may be presented with all the upcoming meetings, their time and place which were scheduled before. Users may also edit and manage user's meetings right from the home page by clicking an “edit meeting” icon, which redirects the user to the manage meetings page, described below. When the user has no scheduled meetings for today, the user may get a note presented within the GUI. The home page may have different pictures, which change according to the time of day (morning, afternoon and evening).

On the top of the screen of the GUI may be presented a main navigation tool—the navigation bar that redirects to various other features of the GUI, including one or more of: Scheduling a new event or meeting. Managing users existing events and meetings. Viewing and adding contacts and creating groups of contacts for easier use. Managing users schedule and groups schedules through an interactive calendar interface.

On the top right corner of the home page of the GUI there may be presented personal information such as a profile picture (which may be modified by clicking on it—a window pops up and lets user choose an image from personal files), email and name.

Next to the profile picture there may be presented a logout button that signs-out the current user and goes to the log-in page for a new user to be logged. To the left of the logout button there is presented a user settings button which splits into 2 sections: First, the interface settings: in this section user may manage the visual look of the GUI such as: Themes, Layouts, Sidebar visualization (collapsed and hover options), Change the language. Second, the user settings: in this section user may manage personal information such as: Name. Phone. Address. Change password.

The button presented next to the settings is the notifications panel, which informs the user every time a meeting with user's participation and/or arrangement has been created, edited or deleted.

On the top left corner of the screen may be presented a logo which will redirect the user to the current home page at any stage of the navigation.

To the right of the logo there may be 2 buttons: the sidebar and personal information icons which are used to collapse and expand the sidebar and the user information (which are located right below the logo) respectively.

On the center of the screen may be presented a calendar, in accordance with some embodiments of the present invention. Under ‘Calendar’ there may be 2 sub sections provided by the GUI. A user calendar presents an organized view of all the ongoing Meetings and Events the current user is connected to (as a Coordinator and as an Invitee). A Group Calendar presents an organized view of all the Meetings and Events of the specific groups the current user is in association with (as a creator or as an Invitee).

The GUI may be designed to provide the user with the ability to navigate through the whole calendar year with the Buttons in the top part of the page that specify the scope of the navigation.

The GUI may be designed with a selection option to view all events and meetings, view by specific group the current user is related to or view all events and meetings related to the current user.

The current user may filter the view of the calendar with exemplary options provide by the GUI. The current user may select to View My meetings, which present only the Meetings and Events the current user is connected to (i.e., as Coordinator or Invitee). The current user may select to View specific group(s), which presents the Meetings and Events that are relevant to a specific group the current user has chosen.

The “View all” option in the GUI presents Every Event and Meeting in the calendar (My meetings/events and all the meetings/events of all the specific groups). The GUI includes an option to view the current user's meetings and/or events as a list by pressing the button that is also located in the top part of the page of the GUI.

In the schedule section the user may perform two main tasks-creating (scheduling) a new meeting and creating a new event. The GUI enables the user who wants to coordinate a new meeting to prioritize 3 key parameters: Attendees (via user credentials of the attendees as registered with the GUI), optional time, and optional location.

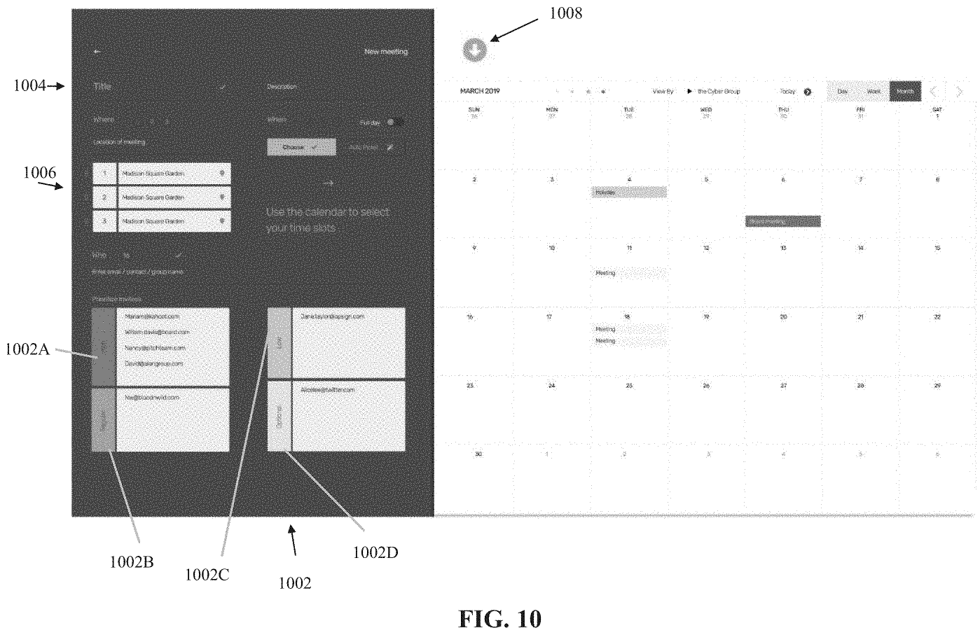

Reference is now made to FIG. 10, which is an exemplary GUI screen presenting a New Meeting Page, in accordance with some embodiments of the present invention.

On the lower left side of the GUI 1002 the user selects new user credentials (of attendees) to a new meeting. New user credentials may be added, for example, using one or more of the following ways: Manually—this will add them automatically to the user's contact. The user may add names from the contact list, by manually writing the contact name or by pressing the “Add from contacts” button which will open a new window with all the contacts of the current user. The current user may choose the contacts, or groups of contacts, for inviting to the meeting by checking the checkbox near the chosen contacts.

The contact list may also have a section of ‘group contacts’ which will include all pre-defined groups of participants which the current user may add to the meeting.

Region 1002 of the GUI is designed for defining a priority rank (e.g., score, location) to user credentials invited to the meeting, in accordance with some embodiments of the present invention.

The current user may prioritize invited user credentials (or groups of invited user credentials), for example, in 4 categories: High 1002A, Regular 1002B, Low 1002C and Optional 1002D. In another implementation, prioritization is according to relative location along a priority scale, enabling fewer or more categories. The 4 categories may be arranged along the priority scale. The prioritization of each invited user credential may be done by navigating (e.g., dragging and dropping) each of the invited user credentials to a certain category and/or location in the priority scale. The priority scale may be divided into regions corresponding to the categories, with the regions arranged along the priority scale. All user credentials within the same region may have the same priority, regardless of relative location within the region. Alternatively, location within the region denotes a sub-ranking within the region.

Region 1004 of the GUI screen may be designed for specifying additional data for the meeting, including name of the meeting and a brief description of the contents that will be covered, in accordance with some embodiments of the present invention.

Region 1006 of the GUI screen is designed for defining location of the meeting. The current user may choose a meeting location from a list of favorite locations by clicking the “Choose from favorites” button. The current user may choose and view the location on the map by pressing the “view on map” link (e.g., provided by a map application). The current user may add a desired location to the list of favorite locations by typing in specific location in the location box and then pressing the “Add to favorites” button.

Optionally, location may be assigned a relative ranking score indicative of relative priority. The current user may select (e.g., up to 5 or fewer or more) optional locations and prioritize between the locations, for example, by assigning numerical values for the relative ranking score to the locations and by that defining their relative importance. Invited user credentials may be able to suggest other meeting locations when the current user selects the option to do so. The prioritization of each optional location may be done by arranging the options in a list (e.g., by dragging and dropping the options) where relative locations along the list denote the relative priority of the option.

The GUI enables the user who wants to coordinate a new meeting two ways to pick the optional time slots: manual selection and auto picker option.

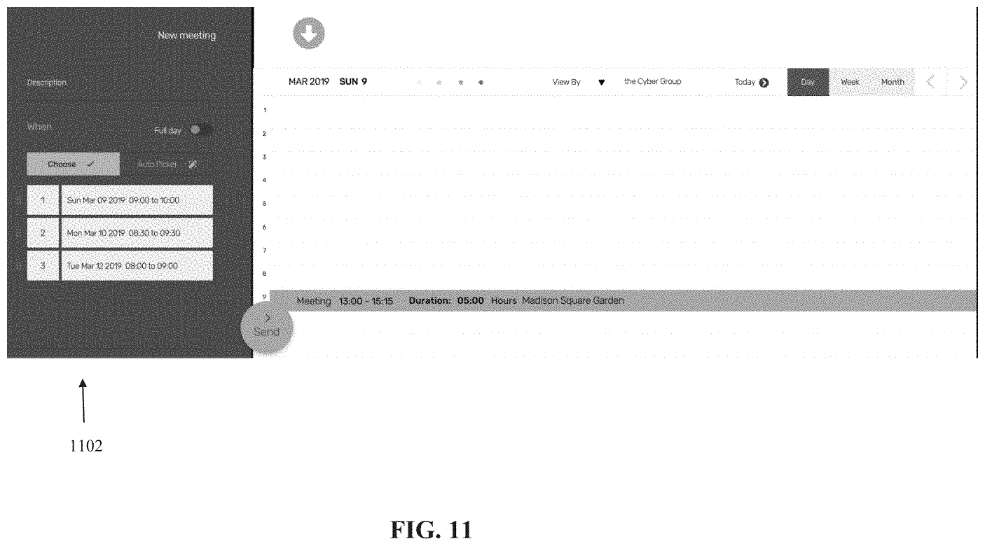

Reference is now made to FIG. 11, which includes an exemplary GUI screen for defining candidate time slots for the meeting manually, in accordance with some embodiments of the present invention. The GUI is designed for selection of multiple (e.g., up to 5 or more or fewer) optional time slots for the meeting. The options may be assigned relative ranking scores indicative of priority. Upon clicking the “choose” button near the time ranges section, a calendar is presented for selection of the most suitable time slots for meetings. Clicking a specific time slot box at any specific time in the calendar may add it as an optional time slot for the meeting. The current user may choose a whole day meeting. The prioritization of each optional time slot may be done by arranging the options in a list (e.g., by dragging and dropping the options) where relative time slots along the list denote the relative priority of the option.

Region 1102 of the GUI is designed or presenting the selected time slots and/or providing a mechanism for selecting ranking scores for prioritizing the selected time slots.

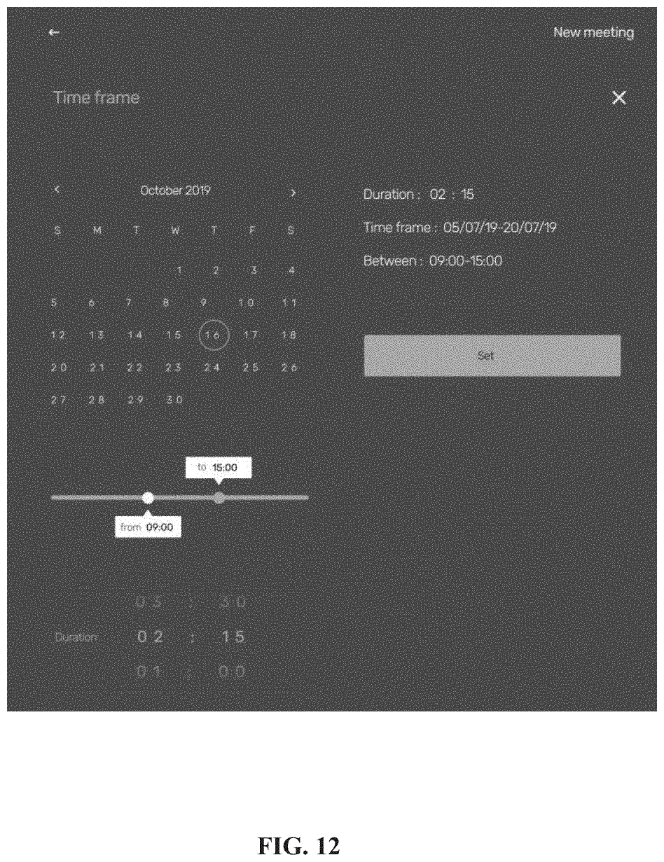

Reference is now made to FIG. 12, which is an exemplary GUI screen for selecting an auto picker option that calculate automatically a single time slot (representing the most optimal selection) for a meeting between all the invited users, in accordance with some embodiments of the present invention. By clicking on the auto picker button—a window pops up and lets user choose several preferences (e.g. Duration of the meeting and time frame of the meeting). The auto picker eliminates the need to select specific time slots and send them to the user credentials as options.

Referring now back to FIG. 10, optionally, the GUI provides an option to make the meeting recurring, for example, in order to eliminate the tedious task of scheduling the same meeting every day or week.

When all the options are set, and the meeting is ready to be issued, and the current user presses the “Send” button 1008 on the center of the GUI page. An email with a link to the meeting invitation is sent to all the user credentials that were included in the meeting.

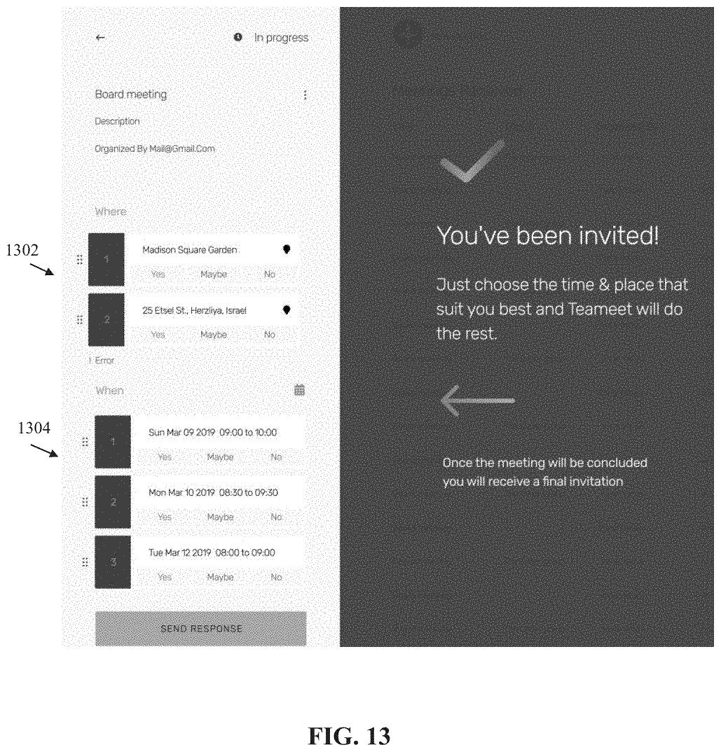

Reference is now made to FIG. 13, which is an exemplary GUI screen depicting an Invitation Page, in accordance with some embodiments of the present invention.

When the current user sends the meeting invitations, each invited user credentials receive an email informing them that they've received a new meeting invitation, with a link to the Invitation Page. The meeting's name, description, location and the time options for the issued meeting are presented within the GUI. Next to each of the optional locations 1302 and/or time slots 1304, each user may respond to the invite by assigning a ranking score (The ranking score may be done by arranging the options in a list where relative locations along the list denote the relative rank of the option) and/or a participation score indicative of likelihood of participation for each of the available time slots by pressing on one of the response buttons, for example, Yes, Maybe, and No, or other methods such as assigning a value or range of probability values indicative likelihood of attending.

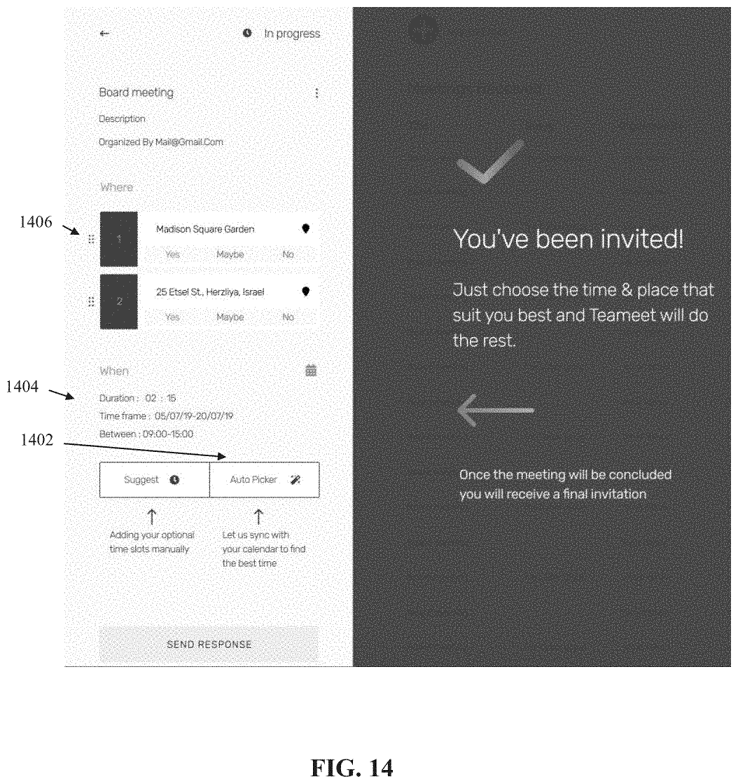

Reference is now made to FIG. 14, which is an exemplary GUI screen depicting a second configuration of an Invitation Page when the current user enabled the auto picker option 1402, in accordance with some embodiments of the present invention.

The GUI enables the invited credential user two options to respond to the invitation. In a first option, manually select and suggest multiple (e.g., up to 5 or more or fewer) optional time slots for the meeting by clicking specific time slot boxes at any specific time in the calendar 1404. Such options may be assigned relative ranking scores indicative of priority. The prioritization of each optional time slot may be done by arranging the options in a list (e.g., by dragging and dropping the options) where relative time slots along the list denote the relative priority of the option. In a second option, select the auto picker option 1402 that calculate automatically a single time slot (representing the most optimal selection) for a meeting based on the preferences set by the current user for a meeting between all the invited credential users. Unregistered user credentials of the GUI may only manually select optional time slots.

Once the invitations are sent, each user credentials responds to the meeting invitation according to their own personal preferences (or the classifier automatically determines the responses) and the code associated with the GUIs automatically aggregates various meeting replies (such as relative ranking scores and participation scores assigned to time slots and locations, and additional new time slots and locations provided by the responses) and uploads the data into the database. After the data from the responses has been collected, the code associated with the GUI calculates optimal times and/or locations for the meeting based on all the data in the database that was acquired from the current user (i.e., Coordinator) and the user credentials (i.e., invitees).

The prioritization process may be initiated automatically, upon receiving responses from all (or other threshold set by the user) invited credential users, or manually by the user.

An exemplary implementation of the prioritization process is now described: time and/or locations of user credentials who are listed higher on the priority list are assigned a heavier weight in the calculation of the optimal time slots and/or optimal locations (i.e., a higher overall score) than for user credentials that are listed lower on the priority scale. The code may evaluate each time slot and/or location of each user credentials based on the relative response ranking score provided by the respective user credentials. User credentials listed higher on the priority scale are evaluated first regarding the final meeting options, while times and locations that were prioritized lower are less likely be calculated into the final meeting options. The finalized optimal times and locations of the meeting with all the information about the user credentials invited to the meeting may be presented in the Ready Meeting Page of the GUI.

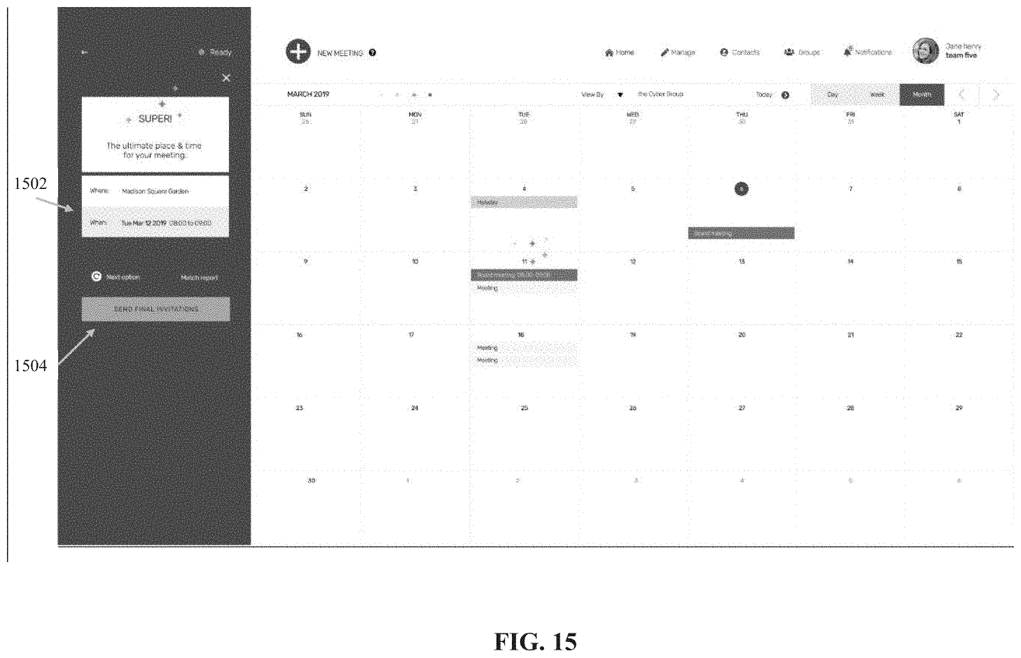

Reference is now made to FIG. 15, which is an exemplary GUI screen for a Ready Meeting Page, representing a concluded meeting in accordance with some embodiments of the present invention. The user may select a single time slot and a single location 1502 of the meeting out of the optimal options calculated by the system and send a final invitation to the invitees.

When the final time slot and location are set, and the current user presses the “Send Final Invitation” 1504, an email with a link to the meeting final invitation is sent to all the user credentials that were included in the meeting.

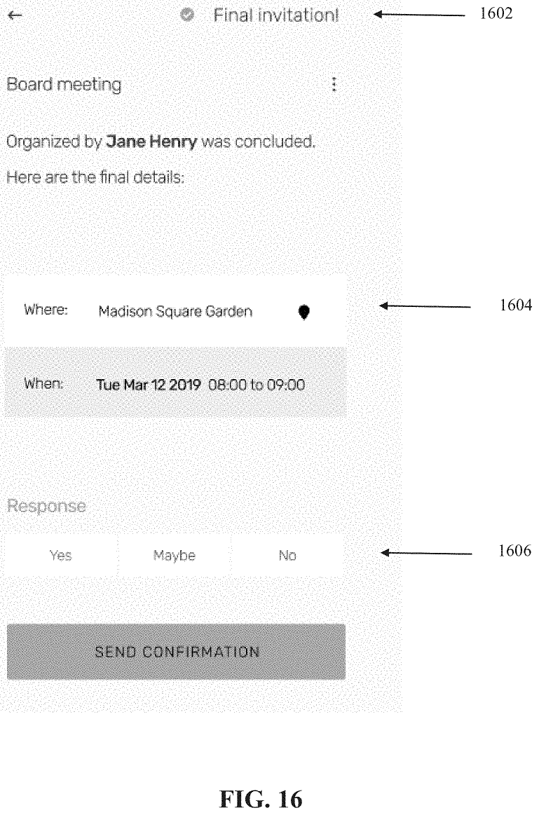

Reference is now made to FIG. 16, which is an exemplary GUI screen depicting a link to a Final Invitation Page, in accordance with some embodiments of the present invention. When the current user sends the final invitation, each invited user credentials receive an email informing them that the meeting has been finalized, with a link to the Final Invitation Page 1602. Next to the final time slot and location 1604, each invited user credential may respond to the invite by a participation score 1606 indicative of likelihood of participation by pressing on one of the response buttons, for example, Yes, Maybe, and No, or other methods such as assigning a value or range of probability values indicative likelihood of attending.

After the meeting has been finalized, the current user may view and manage the information of the meeting via the GUI. The meeting may be presented in the Coordinators calendar of the GUI.

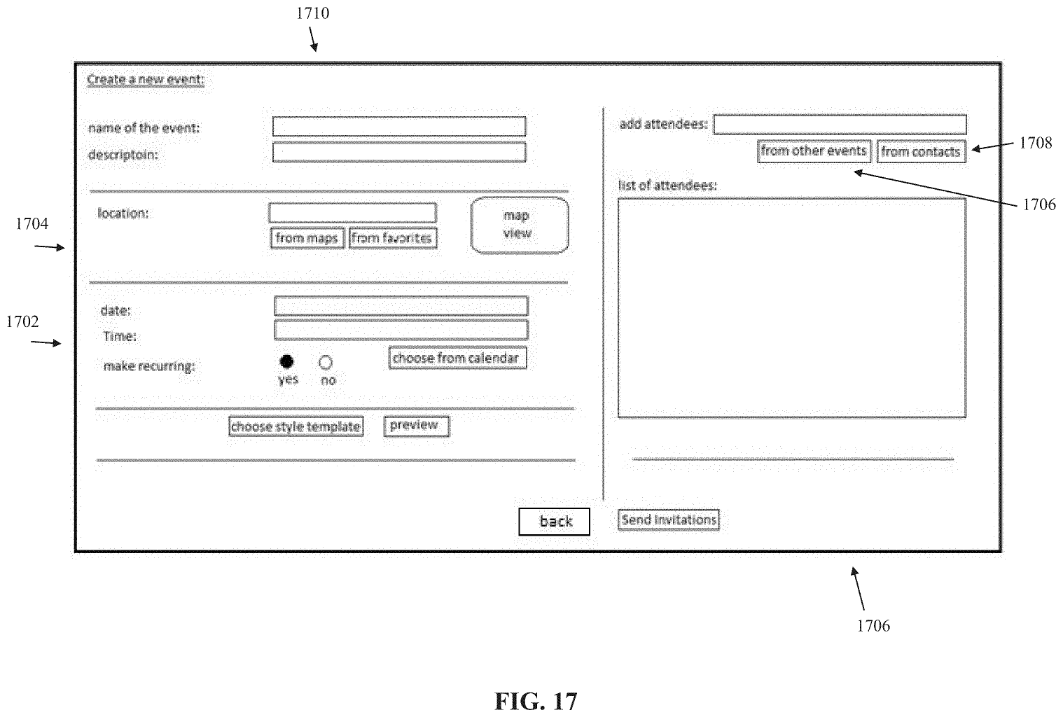

Reference is now made to FIG. 17, which is an exemplary GUI screen depicting a complete page view as seen by a user upon scheduling a new event, in accordance with some embodiments of the present invention. The GUI is designed to enable the current user who wants to create a new meeting, to easily coordinate a multi-participant meeting, using pre-defined list of ‘groups’ that are invited, and/or previous list of attendees from previous events.

An event differs from a meeting in the flow of the planning process. When creating an event, the current user sets a fixed time 1702 and location 1704 and sends the invitations to the selected user credentials, so they can only accept or decline the invitation, based on the information provided in the invitation.

On the right side of the GUI is provided a region 1706 for selecting new user credentials to invite to the newly created event. User credentials may added, for example, manually (this will add them automatically to the user contacts), from the contact list for example by selecting the “from contacts” button 1708. This will pop-up a new window with all the contacts of the current user. The current user may choose the contacts, or groups of contacts, by checking the checkbox near the desired user credentials. The current user may select the list of user credentials (i.e., participants) from previous events, by selecting the “from other events” button 1710 because each event creates a list of participants which may be used for following invitations. Users that previously attended other events may be more likely to attend the current event. The meeting rating score may be computed for the users that attended the other event. The user may select the participants for the current event being planned according to the meeting rating score for users that attended other events.

On the left side of the event invitation presented in the GUI, similarly, to creating a new meeting, region 1710 is designed to enable the current user specifies additional information and settings for the event such as one or more of: General information about the event (name and a brief description). Location of the event 1704—the current user may choose a location from favorites or add a location (e.g., with a map application), and/or adding a location manually. Date and time parameters 1702—the current user may add them manually and/or pick a suitable time for the event from the calendar presented in the GUI. The current user may also make the event recurring (eliminating the tedious task of re-scheduling the same event every time). The current user may select a template style for the invitation and preview it before sending the invites to the selected user credentials.

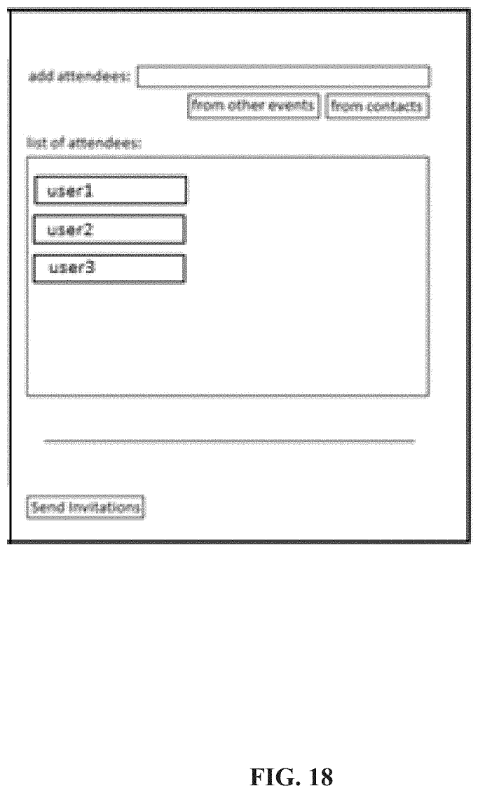

Reference is now made to FIG. 18, which is an exemplary GUI screen depicting a selection of user credentials for attending a new event, in accordance with some embodiments of the present invention.

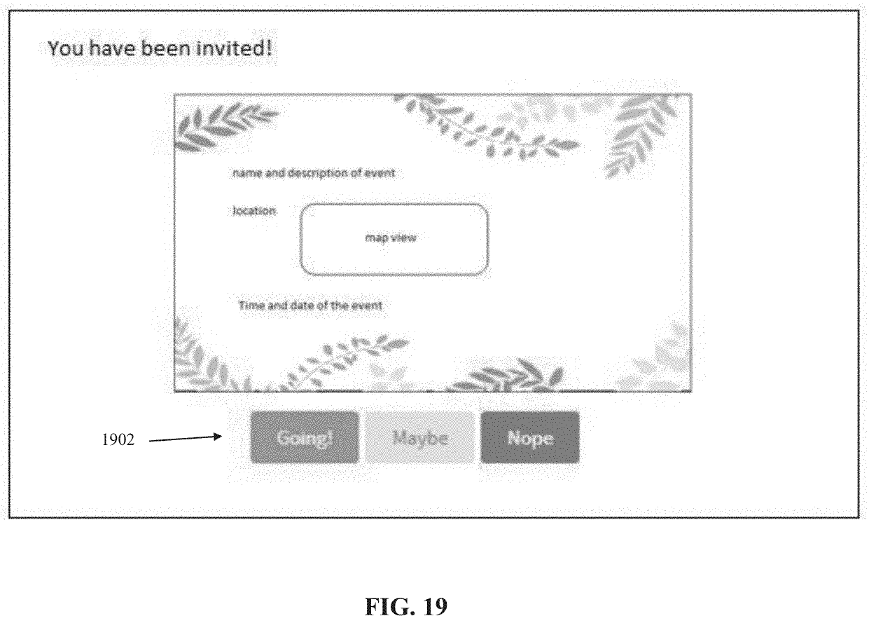

Reference is now made to FIG. 19, which is an exemplary GUI screen depicting an invitation to an event, in accordance with some embodiments of the present invention. Once the current user sends the invitations, the Invitees receive an email (e.g., according to the email of the user credentials) informing them of the event, and a link to the invitation page GUI. The invitation page GUI presents the name, description, location and the time for the issued event. Invitees respond to the invite by selecting on one of the response 1902 options, for example, Going, Maybe, and Nope. Other options may be provided.

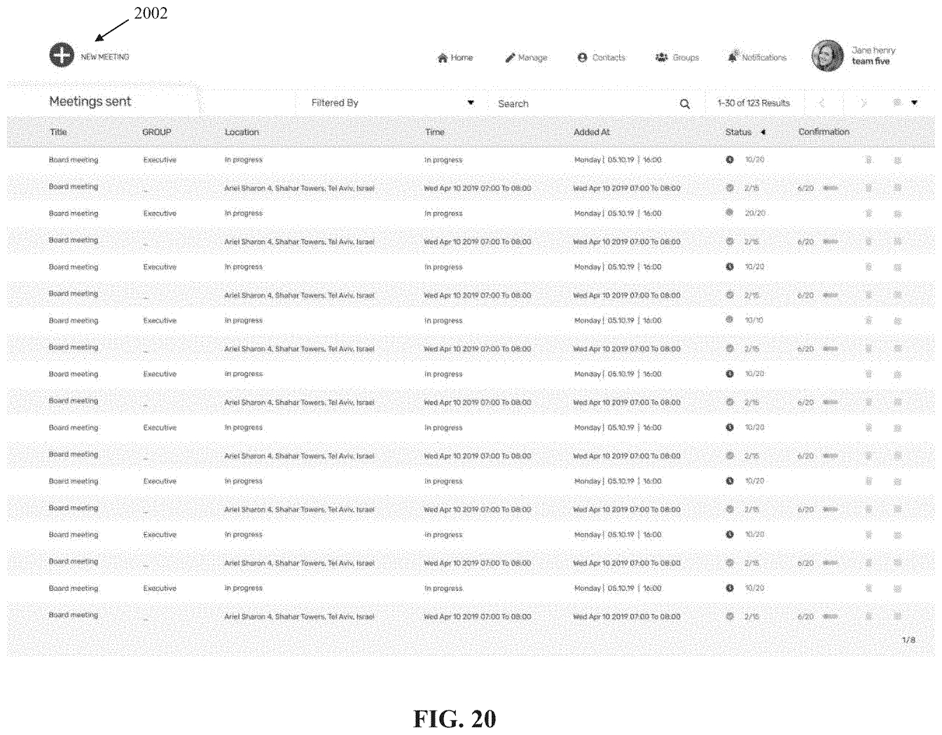

Reference is now made to FIG. 20, which is an exemplary GUI screen depicting a “Meeting Sent Page”, in accordance with some embodiments of the present invention. Under a ‘Manage’ tab of the GUI there may be 2 exemplary sub sections: Meetings and Events. The Meetings section may be divided into 3 main exemplary pages: “Meetings Sent Page”, “Meetings Received Page”, and “Meetings History Page”. Under the “Meetings Sent Page”, the GUI presents a listed view of all the ongoing meetings, that the current user created, including for example: Name, Location, Status of the meeting (pending, finalized), Time of meeting, and When meeting was created.

The listed view that allows sorting the meetings by the above listed parameters and/or the current user has the option of a search bar for a more specific search. The exemplary functions that may be done in this page of the GUI are editing and deleting a meeting, sending a reminder to all the users that are yet to respond to the invitation, and sending a reminder to all Invitees & Attendees.

The current user has the option to create a new meeting by clicking the “new Meeting” Button 2002 at the top left part of the page in the GUI which will redirect the New Meeting Page.

Selecting a specific meeting on the list redirects the current user to the selected specific meeting page which may be, according to the meeting current status.

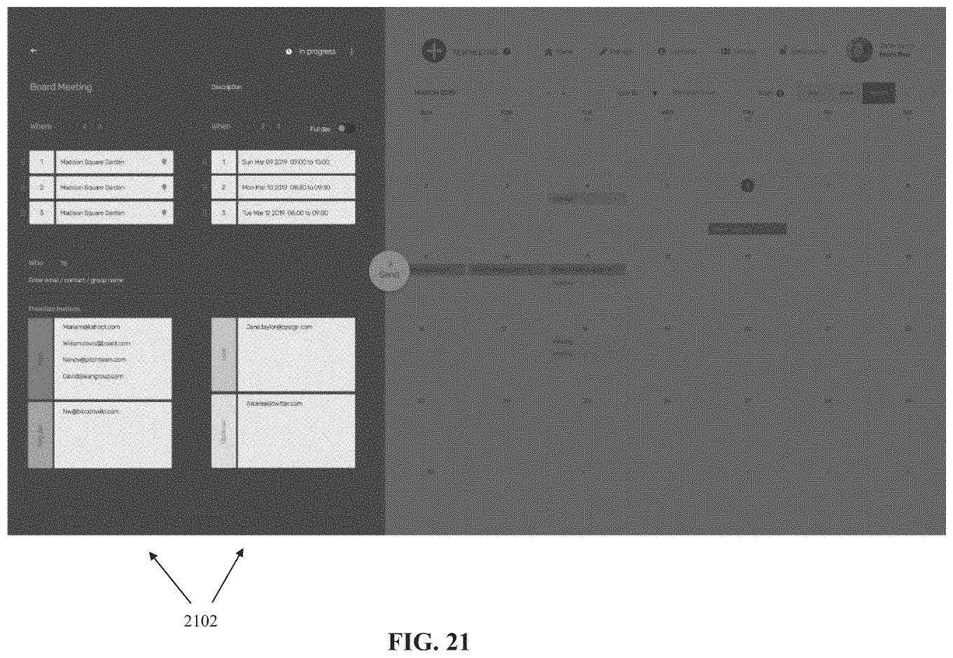

Reference is now made to FIG. 21, which is an exemplary GUI screen depicting an Edit Meeting Page of the GUI, in accordance with some embodiments of the present invention. The bottom left columns 2102 of the page of the GUI include the following exemplary options: Add additional attendees (i.e., user credentials) and put them in the priority scale (e.g., table) similarly to when creating a new meeting. View the current status of the attendees in the priority scale specifying by color.

The GUI presents, within the priority scale, coding (e.g., color, other markings) indicative of likelihood of attendance of the meeting scheduled at the single time slot and the single location by each of the user credentials invited to attend. For example, Red denotes declined the invitation, yellow denotes inconclusive about the meeting, green denotes accepted the invitation, grey denotes yet to respond.

The current user may use the GUI to send a reminder to all the attendees that are “Yet to respond” by clicking the “send reminder” button or send manual reminders simply by pressing the chosen Invitees. The current user may add a personal note to the reminder via the GUI.

The upper left 2104 column of the page of the GUI is like the interface of creating a new meeting, and contains the following exemplary options: Editing the name, description and the location of the meeting, and/or changing the time slot options for the meeting.

After returning to the “Meetings Received Page”, the current user has the option to create a new meeting by clicking the “Add new meeting” Button at the top right part of the page. The GUI page represents a listed view of all the ongoing meetings, (as seen in section “Meetings Sent Page”), that the current user has been invited to (i.e. “Invited Meetings”), including, for example: Name, Location, Status of the meeting (pending, finalized), Time of meeting, When it was created, and The status of the user regarding a specific meeting (accept, reject, maybe or yet to respond). The exemplary functions that may be done in this GUI page are: Responding to an invitation and Deleting a meeting.

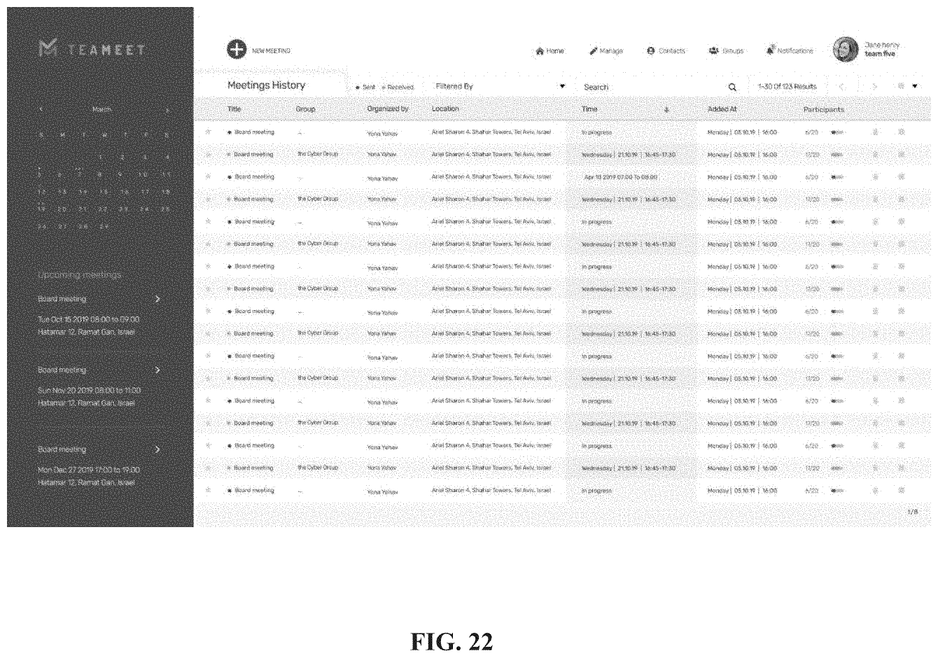

Selecting a specific meeting on the list redirects the current user to the selected meeting invitation page, which may be, according to the meeting current status, Invitation Page (FIGS. 13 and 14) or Final Invitation Page (FIG. 22).

Reference is now made to FIG. 22, which is an exemplary GUI screen presenting a listed view of all the user meetings that occurred in the past (i.e. “Meeting History Page”)—Meetings where the current user acted as Coordinator, and Meetings where the current user acted as an Invitee, in accordance with some embodiments of the present invention.

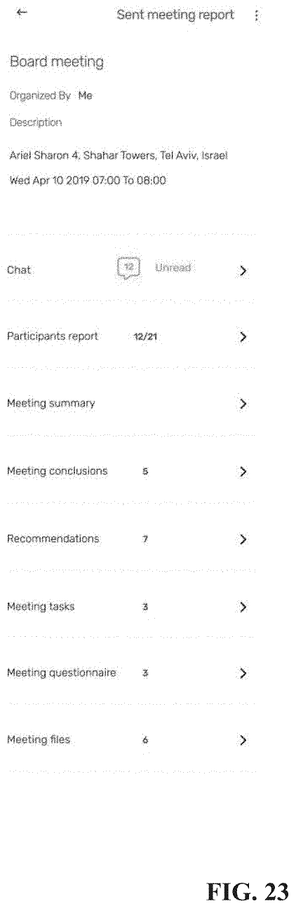

Reference is now made to FIG. 23, which is an exemplary GUI screen depicting a GUI of Meeting Report Page for filling out a post-meeting report, in accordance with some embodiments of the present invention. Upon completion of a Meeting, the Meeting Coordinator (i.e., current user) may receive an email that recommends filling a meeting report regarding the occurred Meeting. Upon creation of the meeting report the Coordinator (i.e., current user) is redirected to the post-meeting page of the GUI, in which the current user may fill in one or more of the following information: Key Meeting details, Meeting conclusions, Next Steps, Tasks, Recommendations for following Meetings, and State which invitees attended the Meeting.

The current user may perform one or more of the following exemplary actions using the GUI: Create a questionnaire—a custom form for communicating with the meeting participants and acquiring data for improving future meetings. Share report with participants—share the current page with all the participants of the meeting. After the report has been filled, the current user may view it in the meetings archive list as seen at the start of the section. View the participants summary regarding the occurred Meeting—the table presents a listed view showing the list of Invitees (i.e., user credentials) and the list of participants (i.e., user credentials) that attended the Meeting, and Edit the table in order to update the status of attendance of Invitees and participants. View/Edit the Meeting conclusions—relevant notes regarding the outcomes of the Meeting. Edit the Meeting conclusions—the Meeting Coordinator and/or the participants are able to edit the conclusions of the Meeting based on their preferences. View/Edit key Meeting details—remarks and notes that came up during the Meeting (such as logistics, organizing and more). View/Edit recommendations—key points that are ought to be taken into consideration towards Next similar meetings. Edit key details & recommendation.

The current user (i.e., Meeting Coordinator) may create Tasks and Steps by selecting the “Add Task” & “Add Step” buttons respectively. Task is a general assignment that is ought to be completed sometime in the future. Step is a part of a general work flow—the actual work that is needed to be done towards the achievement of the task.

Optionally, the Events section is divided into three main exemplary pages: “Events Sent Page”, “Events Received Page”, and “Events History Page”. The “Events Sent Page” of the GUI presents a listed view of all the ongoing events, that the Event Coordinator created, including one or more of the following exemplary items: Name, Location, Time of the event, Number of replies (out of all participants), and Time the event was created.

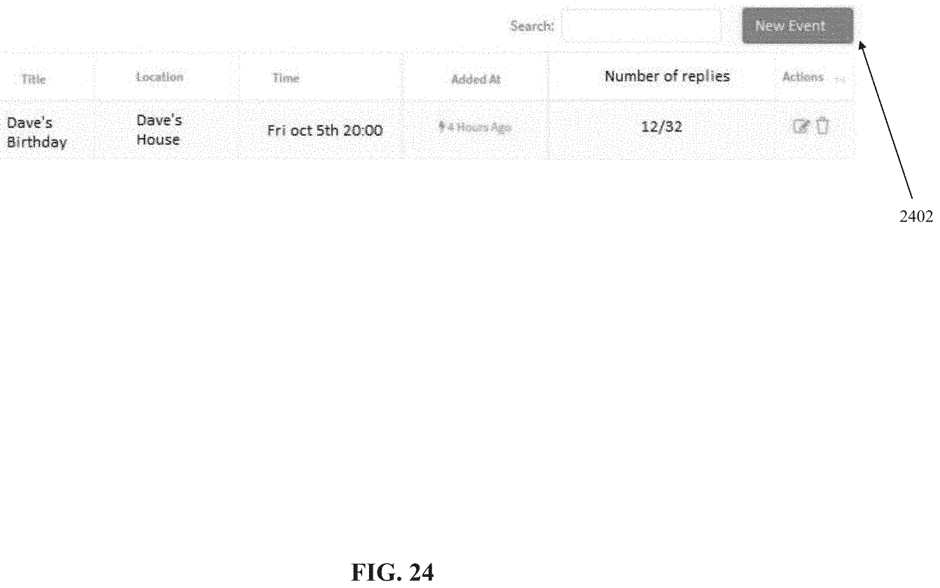

Reference is now made to FIG. 24, which is an exemplary GUI screen depicting the listed view, which allows sorting the events by the parameters mentioned above and provide a search option for a more specific search, in accordance with some embodiments of the present invention.

The exemplary actions that are provided for the current user (i.e., Event Coordinator) include one or more of: Editing an invite, Deleting the invite, and Sending a reminder to the participants that are yet to respond. The current user may be provided with an option to create a new event by clicking a “new event” Button 2402 at the top right part of the page of the GUI which redirects the New event page.

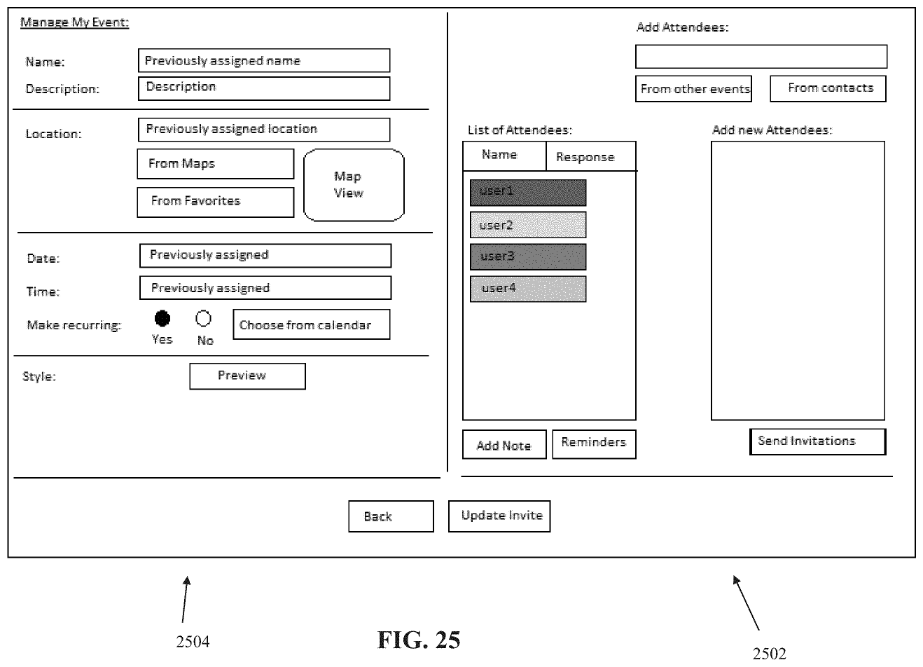

Reference is now made to FIG. 25, which is an exemplary GUI screen that presents detailed information about the event, in accordance with some embodiments of the present invention. Upon selecting a specific event on the list of the GUI, it opens the page of ‘Edit Specific Event’ that shows detailed information about the event.

The right part of the page of the GUI 2502 may present one or more of the following exemplary options: View all the Invitees (i.e., according to user credentials) of the event and their acceptance status regarding the event. Sort the Invitees by name and/or response type. Remove Invitees (with this action the Invitee will receive an email (according to the user credentials) notifying about dismissal from the Event), Send reminders to the Invitees that are yet to respond by pressing the “send reminders” button, Add new attendees (i.e., via user credentials) to the event and send them invitations, Add a note—send a personalized message to all the invitees (i.e., user credentials).

The left part of the page of the GUI 2504 may present one or more of the following exemplary options: Editing the name and description, location and time of the event, Change recurrence option, Preview the invitation style templates.

The page of the GUI presents a listed view of all the ongoing events, (as seen in section “Events Sent Page”) that the respective Invited User (i.e. according to the user credentials) is invited to (i.e. “Events Received Page”). For each event, one or more of the following parameters are presented: Name, Location, Time of the event, Status of the user regarding a specific event (attending, unable to attend, maybe or yet to respond). The actions that the Invited User may perform via the GUI include: deleting an event (therefore declining the invitation).

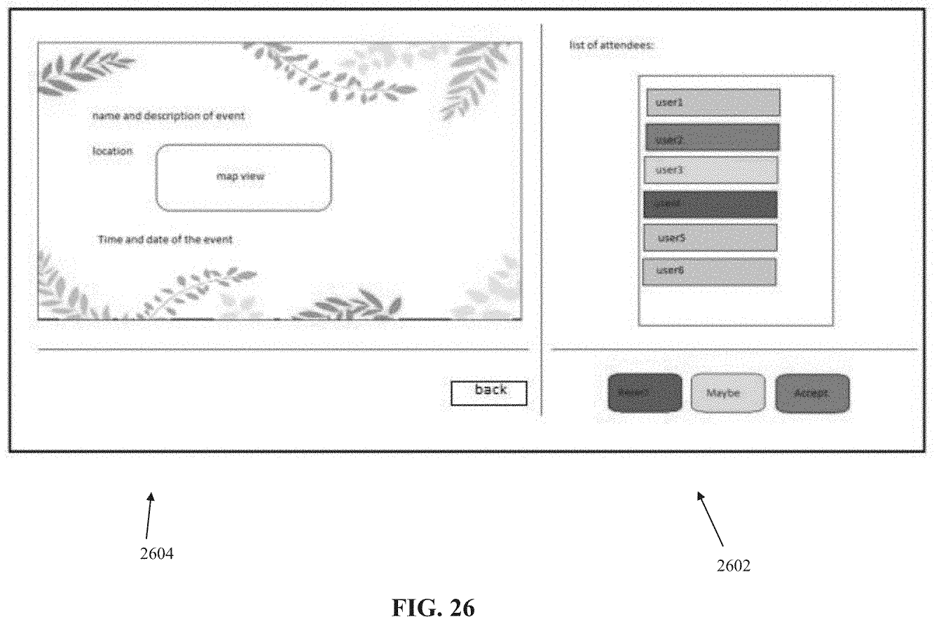

Reference is now made to FIG. 26, which is an exemplary GUI screen presenting a specific selected meeting that the user credentials is invited to, in accordance with some embodiments of the present invention. By choosing a specific meeting on the list via the GUI, the user opens a page of ‘Specific Event Respond Page’.

The right part of the page of the GUI 2602 presents one or more of the following exemplary options: View the different statuses of all the Invitees regarding the meeting (presented by color), the Invited User may also change the previously provided decision regarding the meeting by pressing the response buttons in the bottom part, and the Invited User may send a suggestion to the Event Coordinator.

The right part of GUI 2602 presents a (optional color) coding indicative of likelihood of attendance of the event scheduled at the single time slot by each of the user credentials.

The left part of the page GUI 2604 may present the following exemplary options: View the virtual invitation to the event that was to the Invited User, with all the relevant information regarding the event.

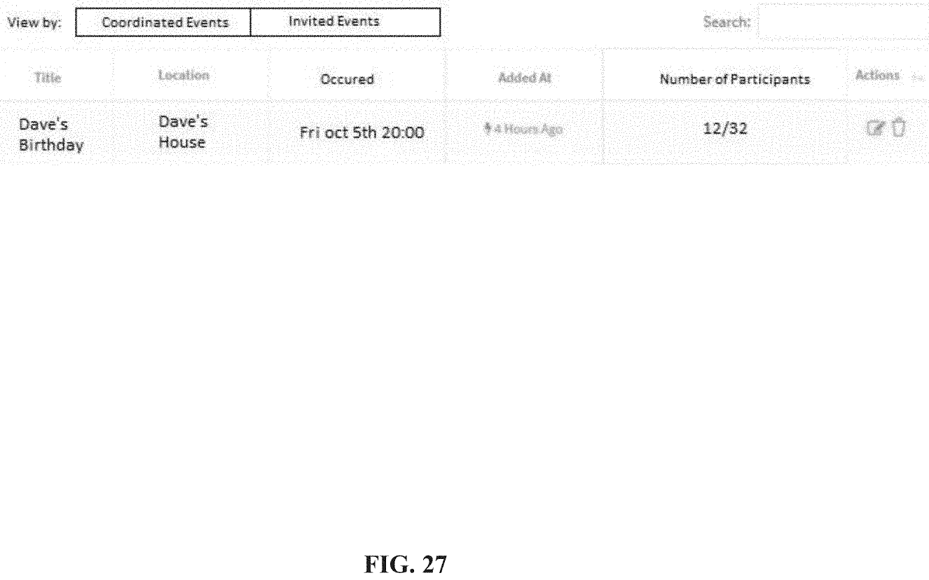

Reference is now made to FIG. 27, which is an exemplary GUI screen presenting an “Events History Page”, in accordance with some embodiments of the present invention. The event archives page presents a listed view of all the current user Events that occurred in the past—Events where the current user acted as Coordinator, and Events where the current user acted as an Invitee.

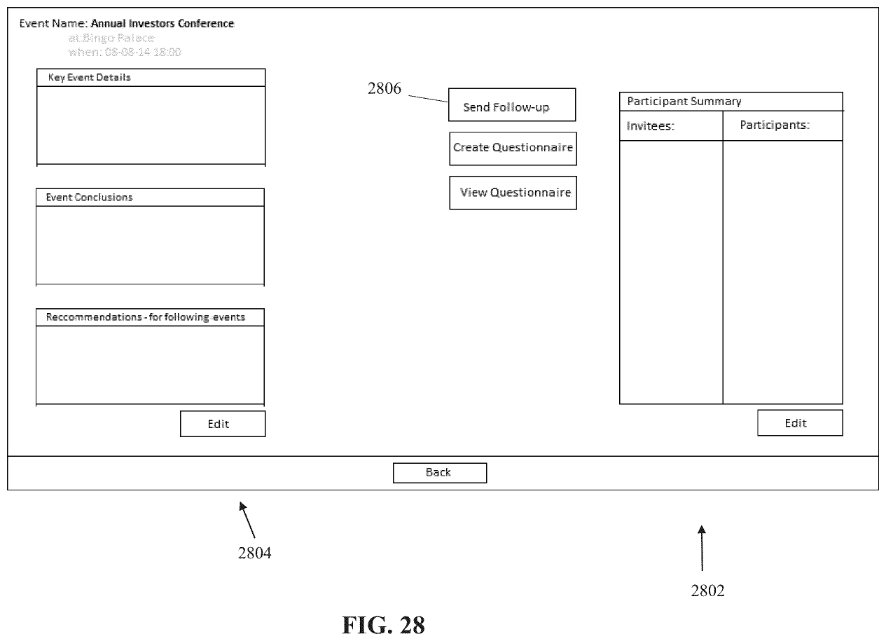

Reference is now made to FIG. 28, which is an exemplary GUI screen presenting an event report, in accordance with some embodiments of the present invention. Upon completion of an Event, the current user (i.e., acting as Event Coordinator) may receive an email that recommends filling a questionnaire regarding the occurred Event. In the questionnaire presented in the GUI, the current user may fill in one or more of the following exemplary information: Key Event details, Event conclusions, Recommendations for following Events, and State which invitees attended the Event. By choosing a specific Event on the archive list of the GUI, the current user opens a page of ‘Questionnaire’.

The right part of the page of the GUI 2802 presents one or more of the following exemplary options: View the participants summary regarding the occurred event—the table presents a listed view showing the list of Invited user credentials and the list of participant user credentials that attended the Event, and/or Edit the table in order to update the status of attendance of Invitees and participants.

The left and middle part 2804 of the page of the GUI present one or more of the following exemplary options: View the Event conclusions—relevant notes regarding the outcomes of the Event. Edit the Event conclusions—the current user (i.e., Event Coordinator) or the user credentials (i.e., participants) may edit the conclusions of the event based on their preferences. View key Event details—remarks and notes that came up during the Event (such as logistics, organizing and more). View recommendations—key points that are ought to be taken into consideration towards Next Similar Events. Edit key details & recommendation.

The current user may send a “follow up” note by selecting the “send follow-up” button of the GUI 2806, for example, to All the Invited user credentials, and/or the participant user credentials.

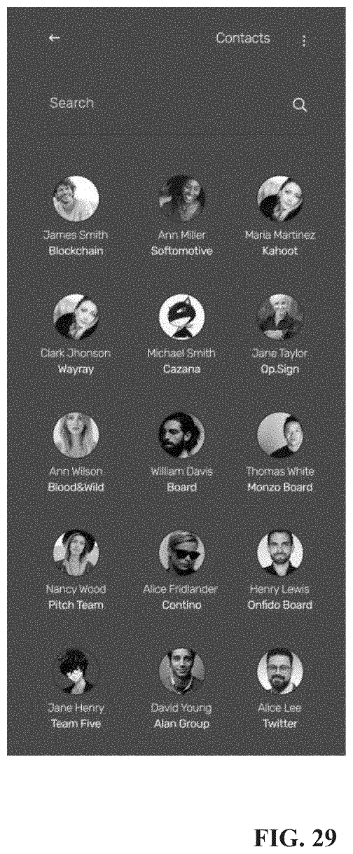

Reference is now made to FIG. 29, which is an exemplary GUI screen presenting User Contacts List, in accordance with some embodiments of the present invention. The User Contact List Page of the GUI may present a detailed view of the contacts of the current user, for example, based on one or more of: Full name, Email, Associated groups, Meeting ratings—a score assigned to each user credentials based on previous attendances to meetings and/or events (users that attended meetings and events on a more frequent basis will have a higher rating assigned to their user credentials than users that did not attend meetings and events that they were invited to), that allows for a cleverer approach toward the specific user credentials when placing them on the priority list, Current status (attending a meeting or event), and/or Personal picture. The meeting rating may be, for example, a percentage of attended meetings versus total invited meetings, and/or a weighted score that takes into account the likelihood of attending the meeting provided by the respective user credentials as responses to invitations versus actual attendance of the meeting and/or event, for example, users for which their response correlates with actual attendance are assigned high scores, and users for which their response does not correlate with actual attendance are assigned lower scores. For example, users that state they are very likely to attend the meeting but do not attend are assigned a low score. Users that state that they are not likely to attend and do attend are assigned a higher score.

It is noted that the GUI may present recommendations that the user may change. For example, the user may change priorities for each meeting and/or event based on the user's preference.

The current user may sort the contacts by these parameters and/or the GUI provides a search bar for a more specific search.

The GUI is designed for adding new contacts or removing contacts by pressing the “add contact” or “remove contact” buttons, respectively.

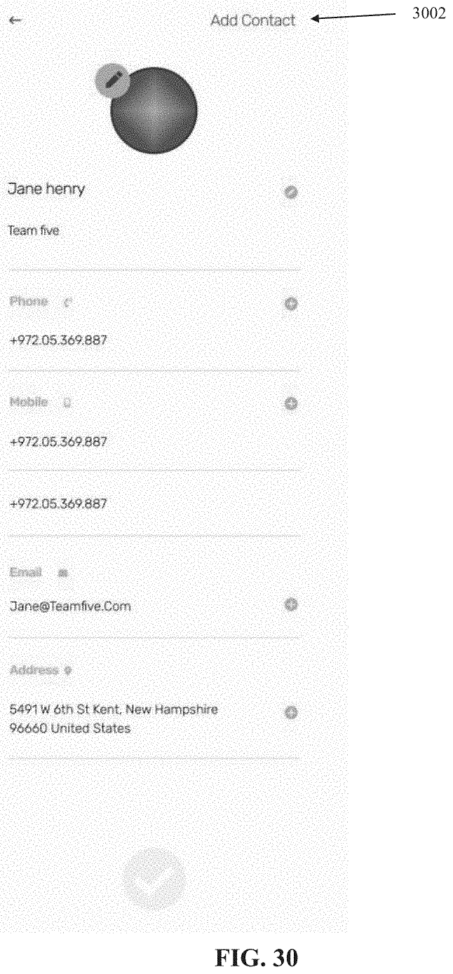

Reference is now made to FIG. 30, which is an exemplary GUI screen presenting creation of a new contact, in accordance with some embodiments of the present invention. The current actions that are supported for the user contacts list include creating a contact, by selecting the “Add Contact” button 3002, pops up a new contact window.

Once all the required information has been filled in the GUI (e.g., contact name, email, and optionally: group reference; organization; and a profile picture), the current user is able to add the new contact to a new meeting.

The GUI is designed for the removal of contacts by pressing the delete button in the rightmost column of the contact presented whom shall be deleted.

The GUI is designed for updating the information of a specific contact by clicking the specific column in the list in the GUI.

The GUI is designed for starting a chat with one of user's contacts by selecting the “Chat” button in the actions column of the GUI, allowing the user credential to send personal messages as well as files and other attachments such as reminders to meetings or events.

The GUI is designed for adding the desired contact to a group (or groups) by selecting the “add to group” button in the actions column, which pops up a new window with all the user related groups (that the current user created and/or has adding privileges)—by selecting the checkbox near the desired groups—the contact is added to the selected group.

The “G” icon in the action column represents that the contact was added from the Google profile (when the current user enabled syncing) and therefore may only be deleted by removing the contact from the Google profile of the current user.

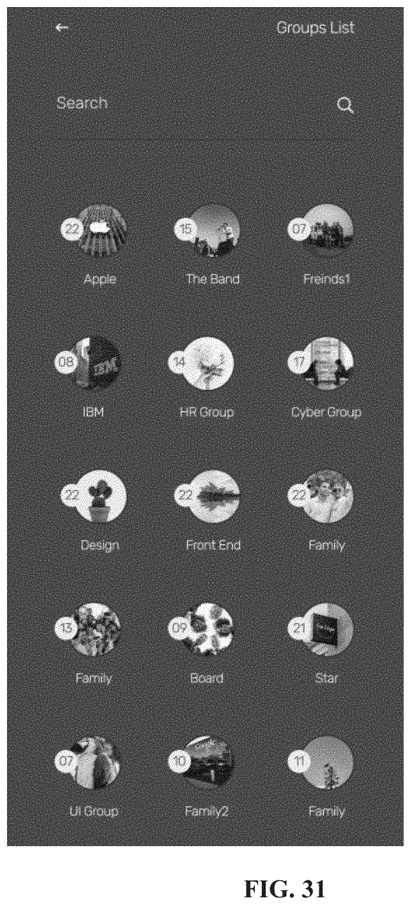

Reference is now made to FIG. 31, which is an exemplary GUI screen presenting groups list, in accordance with some embodiments of the present invention. The Group List Page presents a detailed view of the group contacts of the current user, for example, by: group name, number of contacts, group profile picture, group type (work, friends, org, volunteering, etc. . . . ), name of group creator, and/or creation date. The current user may sort the groups by these parameters and/or the GUI includes a search bar for a more specific search.

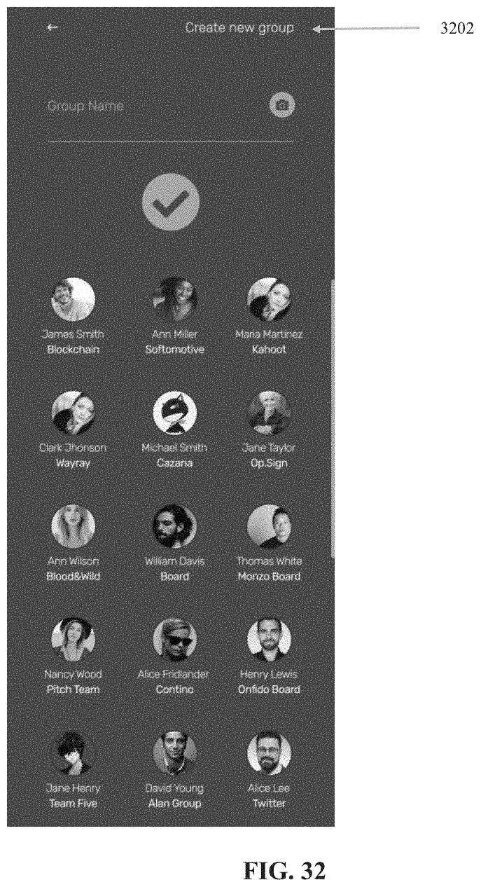

Reference is now made to FIG. 32, which is an exemplary GUI screen presenting creation of a new group, in accordance with some embodiments of the present invention. A new group may be created by choosing the “New group” button located at the top right part of the screen in the GUI. The current user may specify one or more of the following exemplary parameters: The name of the group, The group members and their contact details, The permissions—for each group members. Once all parameters are set, a group is created by pressing the “create group” button 3202 and an email may be sent to all the members (i.e., according to user credentials thereof) that were added to the group informing them of the creation of the group and containing a link to the hub of the group which may be accessed via the GUI. Once a group is created it may be added to the page of the ‘Group List’ on the page. Group contacts shall be either existing registered user credentials of the GUI, or will be invited to join the GUI.

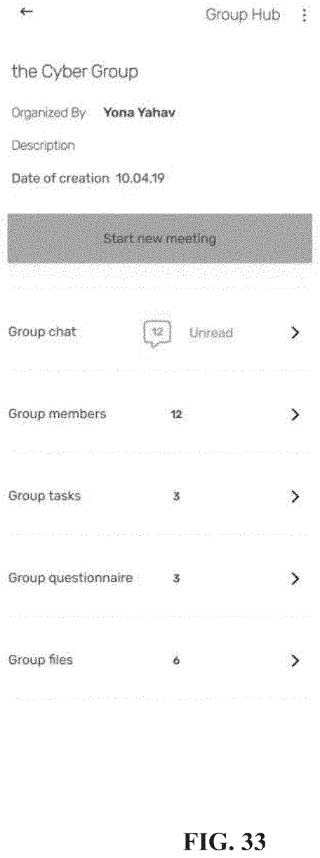

Reference is now made to FIG. 33, which is an exemplary GUI screen presenting a group hub, in accordance with some embodiments of the present invention. Selecting a specific group in the ‘Group List Page’ may redirect to the Specific Group Hub Page.

The GUI is designed to provide one or more of the following exemplary actions the group members have access to in the group hub GUI. Group chat—group members are presented with a communication platform GUI regarding their meetings and events. Group Message and attach file—the current user (i.e., group creator) and members (i.e., according to user credentials thereof) provided with permissions may post important group messages for other members to take notice and are also able to attach files regarding various group meeting or events. Upcoming Events/Meetings—group members may directly view upcoming meetings and events of the current group. Create Meeting/Event—Group creator and members with permissions may create new group Meetings/Events. Reminders of Events/Meetings—custom reminders may be created for each upcoming group Meeting/Event. View Group Calendar—members are presented with the full group calendar that includes upcoming and future Meetings and Events. Folder—selected by one or more of: previous correspondences, previous chats, group messages, and files. Group Log—list, by time, of all group activity.

The GUI is designed to provide group task features, where members are able to view, add and edit the tasks of the group. Exemplary administrative actions include: Editing group parameters (group messages, files). Managing group members (adding and deleting). Delete a group. Granting members group permissions—the current user (i.e., Group creator) may give group members permissions to edit group messages, manage members and create new Events and Meetings.

The hub may present differently within the GUI to the group members (i.e., according to user credentials thereof) and the current user (i.e., Group Creator). The current user is provided with access to all the actions provided for the group contacts and may grant or remove extended permissions. The user credentials (i.e., members) may perform only the actions that they were granted access to (based on their permissions for the specific group).

The GUI is designed to operate based on a hierarchy type management system for groups and/or large organizations. The current user may create groups for various projects and occasions and/or monitor their synchronization on a broad group calendar. This design allows the current user to track collisions and meeting schedules of any number of groups while maintaining the ability to nitpick each group and edit its schedules individually. Since the same user credentials may be members in two or more groups, conflicts of time for scheduling a certain meeting and/or event may occur. Conflicts of time between members of different groups may be automatically detected and presented to the user for resolution. For example, a certain user credential may be assigned to two different groups, which are scheduled at the same time in two different geographical locations. Such conflict may be flagged and presented to the user within the GUI. An automated recommendation may be created and presented to the user and/or automatically made, for example, to assign the certain user to the meeting of the group deemed more important, for example, members of the group are more likely to attend one meeting over another, and/or the certain user credential is flagged as needed with a higher score in one meeting over another. Each group has various functionalities such as group hubs where users may chat and exchange files, it is also possible to make recurring group meetings and create predefined group contacts to ease scheduling new meetings.

The Group Calendar page of the GUI presents a visualized view of the Group calendar. On this calendar the current user may see all the events and meetings of each of the specific groups the current user is a member of (as a creator or as a member).

The GUI is designed to enable the current user to select each group individually and view only the meetings and events that are related only to that group, with this the current user achieves better understanding of the group's affairs and is able to improve planning capabilities.

The GUI may present a group calendar for a specific group. On this calendar the current user may see all the events and meetings of each of the specific group's user is a member (as a Coordination or as an Invitee). It is possible to navigate the calendar through the whole year with the month, week, day, buttons in the top part of the GUI page that specify the scope (Year, Month, Week) of the navigation.

The current user may pick a time box at any specific time in the calendar and by pressing “Enter” the current user is redirected to the Schedule meeting/event page for further customization of the newly created meeting.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant GUI will be developed and the scope of the term GUI is intended to include all such new technologies a priori.

As used herein the term “about” refers to ±10%.

The terms “comprise”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub combination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

What is claimed is:

1. A method of scheduling a meeting by a graphical user interface (GUI), comprising:
presenting within the GUI, a list of user credentials for attending the meeting, and a priority scale having regions indicative of relative priority for attendance;
identifying a gesture performed via the GUI, for navigating a set of the user credentials from the list into respective regions within the priority scale;
sending to each one of the set of user credentials, an invitation including a plurality of time slots and a plurality of locations each associated with a relative ranking score;
receiving a plurality of responses, each associated with relative response ranking score and a participation score indicative of likelihood of participation by the respective user credentials in attending each respective time slot, and each respective location; and
computing optimal time slots and optimal locations by weighting the relative response ranking scores and participation scores for the plurality of time slots and plurality of locations from the plurality of responses, according to the region of the respective user credentials within the priority scale and according to the relative ranking score assigned to each time slot and each location; and
presenting, within the priority scale of the GUI, color coding indicative of likelihood of attendance of the meeting scheduled at the single time slot and the single location by each of the plurality of user credentials.

2. The method of claim 1, wherein the plurality of time slots, the plurality of locations, and associated relative ranking scores are automatically computed by a classifier based on an analysis of a future meeting dataset of a current user organizing the meeting, and based on an analysis of a historical meeting dataset of the current user storing historical scheduled time slots, historical locations, and historical associated relative ranking scores, and wherein the responses are computed by the classifier based on an analysis of a future meeting dataset of each respective user credentials invited to meeting, and based on an analysis of a historical meeting dataset of the respective user credentials storing historical scheduled time slots, historical locations, and historical associated relative ranking scores.

3. The method of claim 1, wherein the plurality of time slots, the plurality of locations, and associated relative ranking scores are automatically recommended by a machine learning model that is dynamically updated and trained by being fed actual real data entered by the users organizing meetings and/or events via the GUI, the received responses, and ground truth of the actual set meeting time slots and/or locations, and actual attendance at the meeting set according to corresponding time slots and locations.

4. The method of claim 3, wherein the machine learning model is trained on and is fed an indication of gestures performed by the user setting up the meeting, and/or by the responding users.

5. The method of claim 3, wherein the machine learning model is trained on and is fed current and/or future geographical locations of the user setting up the meeting and/or of the responding users.

6. The method of claim 1, wherein user credentials of the list are each associated with a presented meeting rating score computed based on previous attendance to invited meetings and/or events, wherein user credentials that have a higher rate of attendance to invited meetings and/or events are assigned a higher score relative to other user credentials that have a lower rate of attendance to invited meetings and/or events.

7. The method of claim 1, wherein list set of user credentials for attending the meeting and/or event includes a plurality of predefined groups of user credentials, wherein the optimal time slots and optimal locations are presented within a calendar in the GUI presenting a summary of scheduled meetings and/or events for the plurality of predefined groups.

8. The method of claim 7, wherein at least one certain user credential is a member of at least two predefined groups, and wherein the GUI automatically determines a conflict when the at least two predefined groups are set to occur during a common time optimal slot at different respective locations.

9. The method of claim 1, wherein list set of user credentials for attending the meeting and/or event includes a plurality of predefined groups of user credentials, and further comprising: presenting a group hub within the GUI in response to selection of one group of the plurality of groups, the group hub including at least one feature selected from the group consisting of: a group chat GUI for interactive communication between a plurality of user credentials of the one group, a group content feature for posting content and viewing the posted content within the GUI between the plurality of user credentials of the one group, an upcoming meeting and/or event feature for viewing within the GUI upcoming scheduled meetings and/or events including the one group, a create meeting and/or event feature for creating new meetings and/or events for the one group via the GUI, a reminder of meeting and/or event feature for creating custom reminders for upcoming scheduled meetings and/or events for transmission to client terminals of the plurality of user credentials of the one group, a view group calendar feature for presenting within the GUI a calendar including upcoming scheduled meetings, a plurality of folders each storing previously posted content and/or chats and/or content for viewing within the GUI, a group log storing a list of activities of the one group for viewing the GUI, and a group report GUI for creating reports from the group data and printing it and/or sharing it between a plurality of user credentials of the one group.

10. The method of claim 1, wherein the meeting comprises a current occurrence of a recurring meeting associated with at least one previous occurrence, wherein the list of user credentials for attending the meeting include user credentials that attended the at least one previous occurrence, and further comprising:
presenting within the GUI, a summary for each at least one previous occurrence of the recurring meeting, the meeting summary including a plurality of fields selected from the group consisting of: invited user credentials, participating user credentials, key meeting details, meeting conclusion, and recommendations for following meetings;
in response to an indication of termination of the current occurrence, generating a meeting feedback form including the plurality of fields;
transmitting the meeting feedback form to the plurality of user credentials;
receiving a plurality of replies; and
aggregating the plurality of fields from the plurality of replies to generate a summary for the current occurrence.

11. The method of claim 1, wherein each invitation sent to each respective user credentials includes a link to access a GUI designed for setting a prioritization of the plurality of time slots and the plurality of locations by identifying a gesture of a respective user arranging the plurality of time slots and the plurality of locations in a list, wherein the relative ranking score is computed according to the relative location in the list of the arranged plurality of time slots and the plurality of locations.

12. A method of scheduling an event by a graphical user interface (GUI), comprising:
presenting within the GUI, a list of user credentials for attending the event, and a priority scale having regions indicative of relative priority for attendance;
identifying a gesture performed via the GUI, for navigating a set of the user credentials from the list into respective regions within the priority scale;
sending to each one of the set of user credentials, an invitation including a single selected time slot and a single selected location;
receiving a plurality of responses, each indicative of acceptance or decline of the invitation by the respective user credentials; and
presenting, within the priority scale of the GUI, color coding indicative of attendance or no-attendance of the event by each of the plurality of user credentials.

13. The method of claim 12, wherein the event comprises a current occurrence of a recurring event associated with at least one previous occurrence, wherein the list of user credentials for attending the event include user credentials that attended the at least one previous occurrence, and further comprising:
presenting within the GUI, a summary for each at least one previous occurrence of the recurring event, the event summary including a plurality of fields selected from the group consisting of: invited user credentials, participating user credentials, key event details, event conclusion, and recommendations for following events;
in response to an indication of termination of the current occurrence, generating an event feedback form including the plurality of fields;
transmitting the event feedback form to the plurality of user credentials;
receiving a plurality of replies; and
aggregating the plurality of fields from the plurality of replies to generate a summary for the current occurrence.

14. The method of claim 12, wherein the GUI includes a selection option that when selected presents a set of user credentials that attended another event, wherein the set of user credentials that attended another event have a meeting rating score computed based on previous attendance to invited meetings and/or events, wherein at least one of the set of user credentials that attended another event is navigate into respective regions within the priority scale.

15. A method of managing groups attending an event or meeting by a graphical user interface (GUI) designed for, comprising:
in response to a first selection, presenting within the GUI, a plurality of predefined groups of user credentials, wherein the plurality of predefined groups are for selection for participation in a scheduled meeting and/or event;
in response to a second selection, presenting within an interactive calendar in the GUI, a summary of scheduled meetings and/or events for the plurality of predefined groups, wherein the interactive calendar is responsive to selection of a certain predefined group and/or certain scheduled meeting and/or certain scheduled event for editing thereof by a user; and
in response to a third selection of one group of the plurality of predefined groups, presenting a group hub within the GUI, the group hub including at least one feature selected from the group consisting of: a group chat GUI for interactive communication between a plurality of user credentials of the one group, a group content feature for posting content and viewing the posted content within the GUI between the plurality of user credentials of the one group, an upcoming meeting and/or event feature for viewing within the GUI upcoming scheduled meetings and/or events including the one group, a create meeting and/or event feature for creating new meetings and/or event for the one group via the GUI, a reminder of meeting and/or event feature for creating custom reminders for upcoming scheduled meetings and/or event for transmission to client terminals of the plurality of user credentials of the one group, a view group calendar feature for presenting within the GUI a calendar including upcoming scheduled meetings and/or events, a plurality of folders each storing previously posted content and/or chats and/or content for viewing within the GUI, a group log storing a list of activities of the one group for viewing the GUI, and a group report GUI for creating reports from the group data and printing it and/or sharing it between a plurality of user credentials of the one group.
